(19) United States
(12) Patent Application Publication
(10) Pub. No.: US 2022/0164667 A1
(43) Pub. Date: May 26, 2022

(54) TRANSFER LEARNING FOR SOUND EVENT CLASSIFICATION

(71) Applicant: QUALCOMM Incorporated, San Diego, CA (US)

(72) Inventors: Fatemeh SAKI, San Diego, CA (US); Yinyi GUO, San Diego, CA (US); Erik VISSER, San Diego, CA (US)

(21) Appl. No.: 17/102,776

(22) Filed: Nov. 24, 2020

(51) Int. Cl. G06N 3/08; G06N 3/04; G06K 9/62

(52) U.S. Cl. CPC G06N 3/084; G06N 3/0454; G06K 9/6202; G06K 9/628; G06K 9/6292

(57) ABSTRACT

A method includes initializing a second neural network based on a first neural network that is trained to detect a first set of sound classes and linking an output of the first neural network and an output of the second neural network to one or more coupling networks. The method also includes, after training the second neural network and the one or more coupling networks, determining whether to discard the first neural network based on an accuracy of sound classes assigned by the second neural network and an accuracy of sound classes assigned by the first neural network.

### I. FIELD

The present disclosure is generally related to sound event classification and more particularly to transfer learning techniques for updating sound event classification models.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities, including, for example a Sound Event Classification (SEC) system that attempts to recognize sound events (e.g., slamming doors, car horns, etc.) in an audio signal.

An SEC system is generally trained using a supervised machine learning technique to recognize a specific set of sounds that are identified in labeled training data. As a result, each SEC system tends to be domain specific (e.g., capable of classifying a predetermined set of sounds). After an SEC system is trained, it is difficult to update the SEC system to recognize new sounds that were not identified in the labeled training data. For example, an SEC system can be trained using a set of labeled audio data samples that include a selection of city noises, such as car horns, sirens, slamming doors, and engine sounds. In this example, if a need arises to also recognize a sound that was not labeled in the set of labeled audio data samples, such as a doorbell, updating the SEC system to recognize the doorbell involves completely retraining the SEC system using both labeled audio data samples for the doorbell as well as the original set of labeled audio data samples. As a result, training an SEC system to recognize a new sound requires approximately the same computing resources (e.g., processor cycles, memory, etc.) as generating a brand-new SEC system. Further, over time, as even more sounds are added to be recognized, the number of audio data samples that must be maintained and used to train the SEC system can become unwieldy.

### III. SUMMARY

In a particular aspect, a device includes one or more processors configured to initialize a second neural network based on a first neural network that is trained to detect a first set of sound classes. The one or more processors are also configured to link an output of the first neural network and an output of the second neural network to one or more coupling networks. The one or more processors are also configured to, after the second neural network and the one or more coupling networks are trained, determine whether to discard the first neural network based on an accuracy of sound classes assigned by the second neural network and an accuracy of sound classes assigned by the first neural network.

In a particular aspect, a method includes initializing a second neural network based on a first neural network that is trained to detect a first set of sound classes and linking an output of the first neural network and an output of the second neural network to one or more coupling networks. The method further includes, after training the second neural network and the one or more coupling networks, determining whether to discard the first neural network based on an accuracy of sound classes assigned by the second neural network and an accuracy of sound classes assigned by the first neural network.

In a particular aspect, a device includes means for initializing a second neural network based on a first neural network that is trained to detect a first set of sound classes and means for linking an output of the first neural network and an output of the second neural network to one or more coupling networks. The device further includes means for determining, after the second neural network and the one or more coupling networks are trained, whether to discard the first neural network based on an accuracy of sound classes assigned by the second neural network and an accuracy of sound classes assigned by the first neural network.

In a particular aspect, a non-transitory computer-readable storage medium includes instructions that when executed by a processor, cause the processor to initialize a second neural network based on a first neural network that is trained to detect a first set of sound classes. The instructions further cause the processor to link an output of the first neural network and an output of the second neural network to one or more coupling networks. The instructions further cause the processor to, after training the second neural network and the one or more coupling networks, determine whether to discard the first neural network based on an accuracy of sound classes assigned by the second neural network and an accuracy of sound classes assigned by the first neural network.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a device that is configured to generate sound identification data responsive to audio data samples and configured to generate an updated sound event classification model.

FIG. 2 a block diagram that illustrates aspects of a sound event classification model according to a particular example.

FIG. 3 is a diagram that illustrates aspects of generating an updated sound event classification model according to a particular example.

FIG. 4 is a diagram that illustrates additional aspects of generating an updated sound event classification model according to a particular example.

FIG. 5 is an illustrative example of a vehicle that incorporates aspects of the device of FIG. 1.

FIG. 6 illustrates virtual reality or augmented reality headset that incorporates aspects of the device of FIG. 1.

FIG. 7 illustrates a wearable electronic device that incorporates aspects of the device of FIG. 1.

FIG. 8 illustrates a voice-controlled speaker system that incorporates aspects of the device of FIG. 1.

FIG. 9 illustrates a camera that incorporates aspects of the device of FIG. 1.

FIG. 10 illustrates a mobile device that incorporates aspects of the device of FIG. 1.

FIG. 11 illustrates an aerial device that incorporates aspects of the device of FIG. 1.

FIG. 12 illustrates a headset that incorporates aspects of the device of FIG. 1.

FIG. 13 illustrates an appliance that incorporates aspects of the device of FIG. 1.

FIG. 14 is a flow chart illustrating aspects of an example of a method of generating a sound event classifier using the device of FIG. 1.

FIG. 15 is a flow chart illustrating aspects of an example of a method of generating a sound event classifier using the device of FIG. 1.

FIG. 16 is a flow chart illustrating aspects of an example of a method of generating a sound event classifier using the device of FIG. 1.

FIG. 17 is a flow chart illustrating aspects of an example of a method of generating a sound event classifier using the device of FIG. 1.

FIG. 18 is a flow chart illustrating aspects of an example of a method of generating a sound event classifier using the device of FIG. 1.

FIG. 19 is a flow chart illustrating aspects of an example of a method of generating a sound event classifier using the device of FIG. 1.

FIG. 20 is a flow chart illustrating aspects of an example of a method of generating a sound event classifier using the device of FIG. 1.

FIG. 21 is a flow chart illustrating aspects of an example of a method of generating a sound event classifier using the device of FIG. 1.

FIG. 22 is a flow chart illustrating aspects of an example of a method of generating a sound event classifier using the device of FIG. 1.

FIG. 23 is a flow chart illustrating aspects of an example of a method of generating a sound event classifier using the device of FIG. 1.

### V. DETAILED DESCRIPTION

Sound event classification models can be trained using machine-learning techniques. For example, a neural network can be trained as a sound event classifier using backpropagation or other machine-learning training techniques. A sound event classification model trained in this manner can be small enough (in terms of storage space occupied) and simple enough (in terms of computing resources used during operation) for a portable computing device to store and use the sound event classification model. However, the training process uses significantly more processing resources than are used to perform sound event classification using the trained sound event classification model. Additionally, the training process uses a large set of labeled training data including many audio data samples for each sound class that the sound event classification model is being trained to detect. Thus, it may be prohibitive, in terms of memory utilization or other computing resources, to train a sound event classification model from scratch on a portable computing device or another resource limited computing device. As a result, a user who desires to use a sound event classification model on a portable computing device may be limited to downloading pre-trained sound event classification models onto the portable computing device from a less resource constrained computing device or a library of pre-trained sound event classification models. Thus, the user has limited customization options.

The disclosed systems and methods facilitate knowledge migration from a previously trained sound event classification model (also referred to as a “source model”) to a new sound event classification model (also referred to as a “target model”), which enables learning new sound event classes without forgetting previously learned sound event classes and without re-training from scratch. In a particular aspect, in order to migrate the previously learned knowledge from the source model to the target one, a neural adapter is employed. The source model and the target model are merged via the neural adapter to form a combined model. The neural adapter facilitates the target model to learn new sound events with minimal training data and maintaining a similar performance to the source model.

Thus, the disclosed systems and methods provide a scalable sound event detection framework. In other words, a user can add a customized sound event to an existing source model, whether the source model is part of an ensemble of binary classifiers or is a multi-class classifier. In some aspects, the disclosed systems and methods enable the target model to learn multiple new sound event classes at the same time (e.g., during a single training session).

The disclosed learning techniques may be used for continuous learning, especially in applications where there is a constraint on the memory footprint. For example, the source model may be discarded after the target model is trained, freeing up memory associated with the source model. To illustrate, when the target model is determined to be mature (e.g., in terms of classification accuracy or performance), the source model and the neural adapter can be discarded, and the target model can be used alone. In some aspects, the maturity of the target model is determined based on performance of the target model, such as performance in recognizing sound event classes that the source model was trained to recognize. For example, the target model may be considered mature when the target model is able to recognize sound event classes with at least the same accuracy as the source model. In some aspects, the target model can later be used as a source model for learning additional sound event classes.

In a particular aspect, no training of the sound event classification models is performed while the system is operating in an inference mode. Rather, during operation in the inference mode, existing knowledge, in the form of one or more previously trained sound event classification models (e.g., the source model), is used to analyze detected sounds. More than one sound event classification model can be used to analyze the sound. For example, an ensemble of sound event classification models can be used during operation in the inference mode. A particular sound event classification model can be selected from a set of available sound event classification models based on detection of a trigger condition. To illustrate, a particular sound event classification model is used, as the active sound event classification model, whenever a certain trigger (or triggers) is activated. The trigger(s) may be based on locations, sounds, camera information, other sensor data, user input, etc. For example, a particular sound event classification model may be trained to recognize sound events related to crowded areas, such as theme parks, outdoor shopping malls, public squares, etc. In this example, the particular sound event classification model may be used as the active sound event classification model when global positioning data indicates that a device capturing sound is at any of these locations. In this example, the trigger is based on the location of the device capturing sound, and the active sound event classification model is selected and loaded (e.g., in addition to or in place of a previous active sound event classification model) when the device is detected to be in the location. In a particular aspect, while operating in the inference mode, audio data samples representing sound events that are not recognized can be stored and can subsequently be used to update a sound event classification model using the disclosed learning techniques.

The disclosed systems and methods use transfer learning techniques to generate updated sound event classification models in a manner that is significantly less resource intensive than training sound event classification models from scratch. According to a particular aspect, the transfer learning techniques can be used to generate an updated sound event classification model based on a previously trained sound event classification model (also referred to herein as a “base model”). The updated sound event classification model is configured to detect more types of sound events than the base model is. For example, the base model is trained to detect any of a first set of sound events, each of which corresponds to a sound class of a first set of sound classes, and the updated sound event classification model is trained to detect any of the first set of sound events as well as any of a second set of sound events, each of which corresponds to a sound class of a second set of sound classes. Accordingly, the disclosed systems and methods reduce the computing resources (e.g., memory, processor cycles, etc.) used to generate an updated sound event classification model. As one example of a use case for the disclosed system and methods, a portable computing device can be used to generate a custom sound event detector.

According to a particular aspect, an updated sound event classification model is generated based on a previously trained sound event classification model, a subset of the training data used to train the previously trained sound event classification model, and one or more sets of training data corresponding to one or more additional sound classes that the updated sound event classification model is to be able to detect. In this aspect, the previously trained sound event classification model (e.g., a first neural network) is retained and unchanged. Additionally, a copy of the previously trained sound event classification model is generated and modified to have a new output layer. The new output layer includes an output node for each sound class that the updated sound event classification model (e.g., a second neural network) is to be able to detect. For example, if the first model is configured to detect ten distinct sound classes, then an output layer of the first model may include ten output nodes. In this example, if the updated sound event classification model is to be trained to detect twelve distinct sound classes (e.g., the ten sound classes that the first model is configured to detect plus two additional sound classes), then the output layer of the second model includes twelve output nodes.

One or more coupling networks are generated to link output of the first model and output of the second model. For example, the coupling network(s) convert an output of the first model to have a size corresponding to an output of the second model. To illustrate, in the example of the previous paragraph, the first model includes ten output nodes and generates an output having ten data elements, and the second model includes twelve output nodes and generates an output having twelve data elements. In this example, the coupling network(s) modify the output of the first model to have twelve data elements. The coupling network(s) also combine the output of the second model and the modified output of the first model to generate a sound classification output of the updated sound event classification model.

The updated sound event classification model is trained using labeled training data that includes audio data samples and labels for each sound class that the updated sound event classification model is being trained to detect or classify. However, since the first model is already trained to accurately detect the first set of sound classes, the labeled training data includes far fewer audio data samples for the first set of sound classes than were originally used to train the first model. To illustrate, the first model can be trained using hundreds or thousands of audio data samples for each sound class of the first set of sound classes. In contrast, the labeled training data used to train the updated sound event classification model can include tens or fewer of audio data samples for each sound class of the first set of sound classes. The labeled training data also includes audio data samples for each sound class of the second set of sound classes. The audio data samples for the second set of sound classes can also include tens or fewer audio data samples for each sound class of the second set of sound classes.

Backpropagation or another machine-learning technique is used to train the second model and the one or more coupling networks. During this process, the first model is unchanged, which limits or eliminates the risk that the first model will forget its prior training. For example, during its previous training, the first model was trained using a large labeled training data set to accurately detect the first set of sound classes. Retraining the first model using the relatively small labeled training data set used during retraining risks causing the accuracy of the first model to decline (sometimes referred to as “forgetting” some of its prior training). Retaining the first model unchanged while training the updated sound event detector model mitigates the risk of forgetting the first set of sound classes.

Additionally, before training, the second model is identical to the first model except for the output layer of the second model and interconnections therewith. Thus, at the starting point of the training, the second model is expected to be closer to convergence (e.g., closer to a training termination condition) than a randomly seeded model. As a result, fewer iterations should be needed to train the second model than were used to train the first model.

After the updated sound event classification model is trained, either the second model or the updated sound event classification model (including the first model, the second model, the one or more coupling networks, and links therebetween) can be used to detect sound events. For example, a model checker can select an active sound event classification model by performing one or more model checks. The model checks may include determining whether the second model exhibits significant forgetting relative to the first model. To illustrate, classification results generated by the second model can be compared to classification results generated by the first model to determine whether the second model assigns sound classes as accurate as the first model does. The model checks may also include determining whether the second model by itself (e.g., without the first model and the one or more coupling networks) generates classification results with sufficient accuracy. If the second model satisfies the model checks, the model checker designates the second model as the active sound event classifier. In this circumstance, the first model is discarded or remains unused during sound event classification. If the second model does not satisfy the model checks, the model checker designates the updated sound event classification model (including the first model, the second model, the one or more coupling networks, and links therebetween) as the active sound event classifier. In this circumstance, the first model is retained as part of the updated sound event classification model.

Thus, the model checker enables designation an active sound event classifier in a manner conserves computing resources. For example, if the second model alone is sufficiently accurate, the first model and the one or more coupling networks are discarded, which reduces an in memory footprint of the active sound event classifier. The resulting active sound classifier (e.g., the second model) is similar in memory footprint to the first model but has improved functionality relative to the first model (e.g., the second model is able to recognized sound classes that the first model cannot, and retains similar accuracy for sound classes that the first model can recognize). Relative to using the first model, the second model, and the one or more coupling networks together as the active sound event classifier, using the second model alone as the active sound event classifier uses fewer computing resources, such as less processor time, less power, and less memory. Further, even using the first model, the second model, and the one or more coupling networks together as the active sound event classifier provides users with the ability to generate customized sound event classifiers without retraining from scratch, which saves considerable computing resources, including memory to store a large library of audio data samples for each sound class, power and processing time to train a neural network to perform adequately as a sound event classifier, etc.

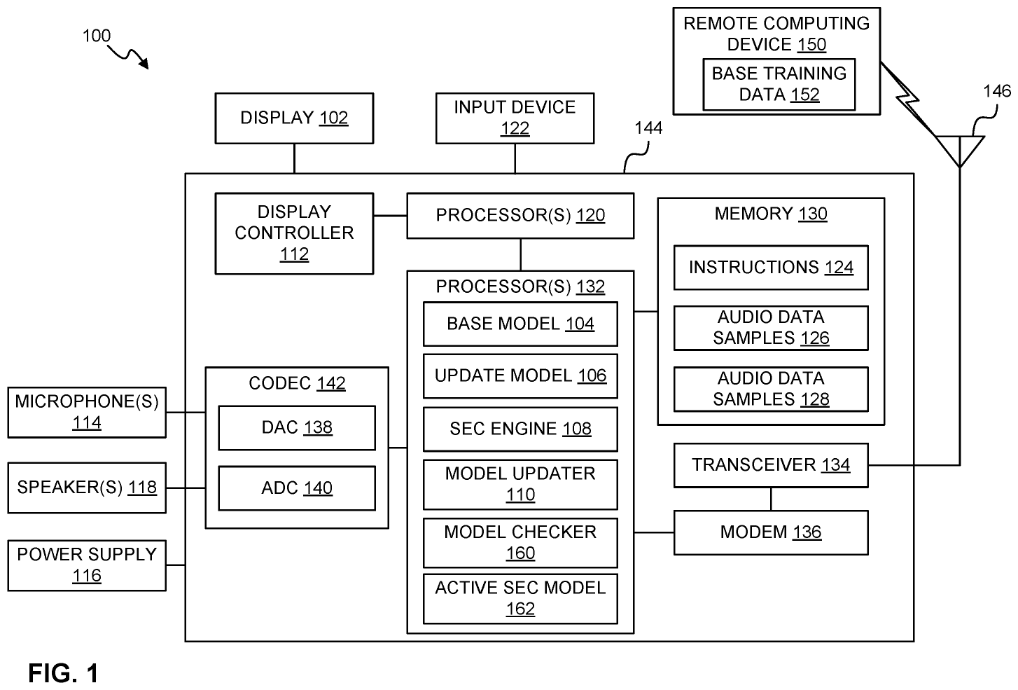

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 100 including one or more microphone (“microphone(s) 114 in FIG. 1), which indicates that in some implementations the device 100 includes a single microphone 114 and in other implementations the device 100 includes multiple microphones 114. For ease of reference herein, such features are generally introduced as “one or more” features and are subsequently referred to in the singular or optional plural (generally indicated by terms ending in “(s)”) unless aspects related to multiple of the features are being described.

The terms “comprise,” “comprises,” and “comprising” are used herein interchangeably with “include,” “includes,” or “including.” Additionally, the term “wherein” is used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” refers to two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of an example of a device 100 that includes an active sound event classification (SEC) model 162 that is configured to generate sound identification data responsive to input of audio data samples. In FIG. 1, the device 100 is also configured to update the active sound event classification model 162. In some implementations, a remote computing device 150 updates the active sound event classification model 162, and the device 100 uses the active sound event classification model 162 to generate sound identification data responsive to audio data samples. In some implementations, the remote computing device 150 and the device 100 cooperate to update the active sound event classification model 162, and the device 100 uses the active sound event classification model 162 to generate sound identification data responsive to audio data samples. In various implementations, the device 100 may have more or fewer components than illustrated in FIG. 1.

In a particular implementation, the device 100 includes a processor 120 (e.g., a central processing unit (CPU)). The device 100 may include one or more additional processor(s) 132 (e.g., one or more DSPs). The processor 120, the processor(s) 132, or both, may be configured to generate sound identification data, to update the active sound event classification model 162, or both. For example, in FIG. 1, the processor(s) 132 include a sound event classification (SEC) engine 108. The SEC engine 108 is configured to analyze audio data samples using the active sound event classification model 162.

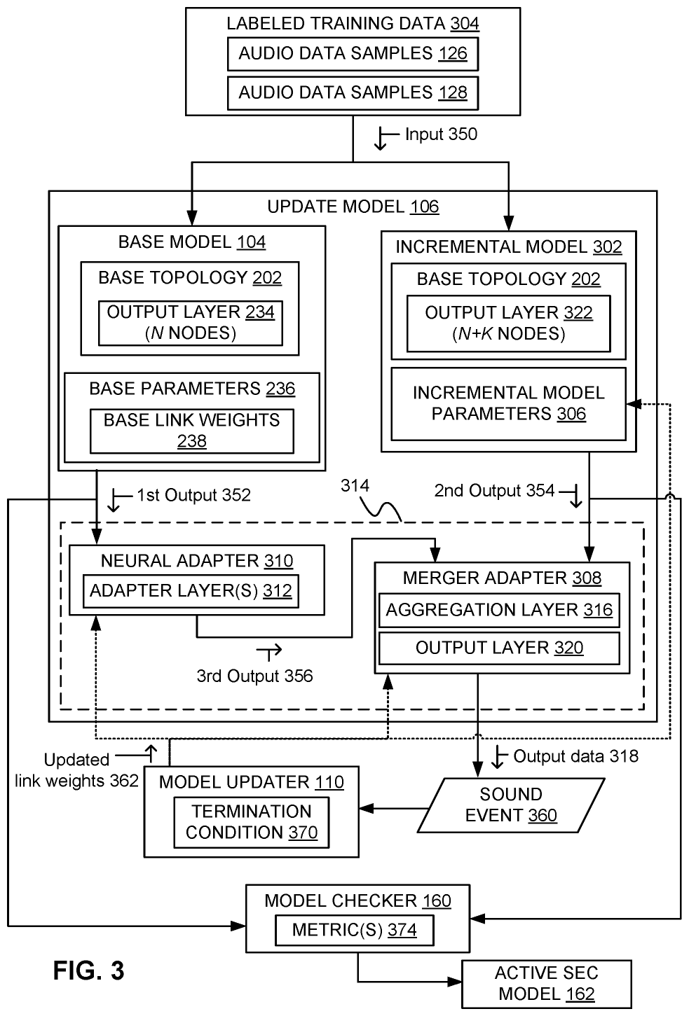

The active SEC model 162 is a previously trained sound event classification model. For example, before the active SEC model 162 is updated, a base model 104 is designated as the active SEC model 162. In a particular aspect, updating the active SEC model 162 includes generating and training an update model 106. As described further with reference to FIG. 3, the update model 106 includes the base model 104 (e.g., a first neural network), an incremental model (e.g., a second neural network, such as the incremental model 302 of FIG. 3), and one or more coupling networks (e.g., coupling network(s) 314 of FIG. 3) linking the base model 104 and the incremental model. In this context, “linking” models or networks refers to establishing a connection (e.g., a data connection, such as a pointer; or another connection, such as a physical connection) between the models or networks. “Linking” may be used interchangeably herein with “coupling” or “connecting.” For example, the base model 104 may be linked to the coupling network(s) by using a pointer or a designated memory location. In this example, output of the base model 104 is stored at a location indicated by the pointer or at the designated memory location, and the coupling network(s) is configured to retrieve the output of the base model 104 from the location indicated by the pointer or at the designated memory location. Linking can also, or alternatively, be accomplished by other mechanisms that cause the output of the base model 104 and the incremental model to be accessible to the coupling network(s).

After the update model 106 is trained by the model updater 110, the model checker 160 determines whether to discard the base model 104. To illustrate, the model checker 160 determines whether to discard the base model 104 based on an accuracy of sound classes assigned by the incremental model and an accuracy of sound classes assigned by the base model 104. In a particular aspect, if the model checker 160 determines that the incremental model alone is sufficiently accurate (e.g., satisfies an accuracy threshold), the incremental model is designated as the active SEC model 162 and the base model 104 is discarded. If the model checker 160 determines that the incremental model is not sufficiently accurate (e.g., fails to satisfy the accuracy threshold), the update model 106 is designated as the active SEC model 162 and the base model 104 is retained as part of the update model 106. In this context, “discarding” the base model 104 refers to deleting the base model 104 from the memory 130, reallocating a portion of the memory 130 allocated to the base model 104, marking the base model 104 for deletion, archiving the base model 104, moving the base model 104 to another memory location for inactive or unused resources, retaining the base model 104 but not using the base model 104 for sound event classification, or other similar operations.

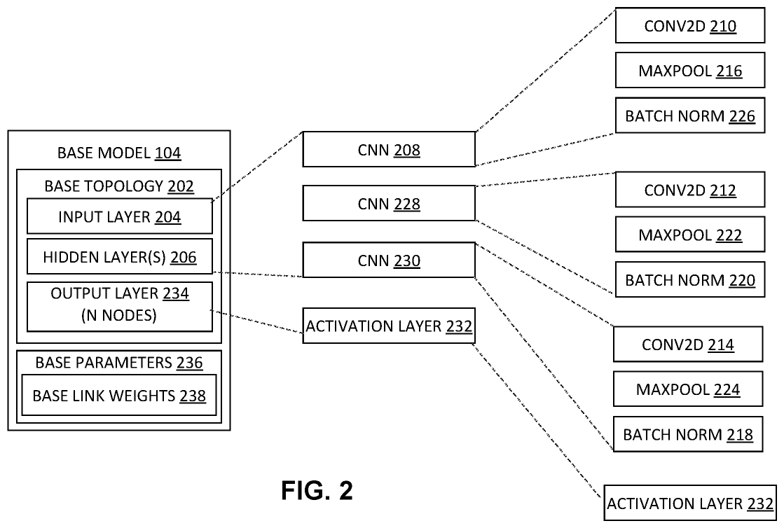

In some implementations, another computing device, such as the remote computing device 150, trains the base model 104, and the base model 104 is stored on the device 100 as a default model, or the device 100 downloads the base model 104 from the other computing device. In some implementations, the device 100 trains the base model 104. Training the base model 104 entails use of a relatively large set of labeled training data (e.g., base training data 152 in FIG. 1). In some implementations whether the remote computing device 150 or the device 100 trains the base model 104, the base training data 152 is stored at the remote computing device 150, which may have greater storage capacity (e.g., more memory) than the device 100. FIG. 2 illustrates examples of particular implementations of the base model 104.

In FIG. 1, the device 100 also includes a memory 130 and a CODEC 142. The memory 130 stores instructions 124 that are executable by the processor 120, or the processor(s) 132, to implement one or more operations described with reference to FIGS. 3-15. In an example, the instructions 124 include or correspond to the SEC engine 108, the model updater 110, the model checker 160, or a combination thereof. The memory 130 may also store the active SEC model 162, which may include or correspond to the base model 104, the update model 106, or an incremental model (e.g., incremental model 302 of FIG. 3). Further, in the example illustrated in FIG. 1, the memory 130 stores audio data samples 126 and audio data samples 128. The audio data samples 126 include audio data samples representing one or more of a first set of sound classes used to train the base model 104. That is, the audio data samples 126 include a relatively small subset of the base training data 152. In some implementations, the device 100 downloads the audio data samples 126 from the remote computing device 150 when the device 100 is preparing to update the active SEC model 162. The audio data samples 128 include audio data samples representing one or more of a second set of sound classes used to train the update model 106. In a particular implementation, the device 100 captures one or more of the audio data samples 128 (e.g., using the microphone(s) 114). In some implementations, the device 100 obtains one or more of the audio data samples 128 from another device, such as the remote computing device 150. FIG. 3 illustrates an example of operation of the model updater 110 and the model checker 160 to update the active SEC model 162 based on the base model 104, the audio data samples 126, and the audio data samples 128.

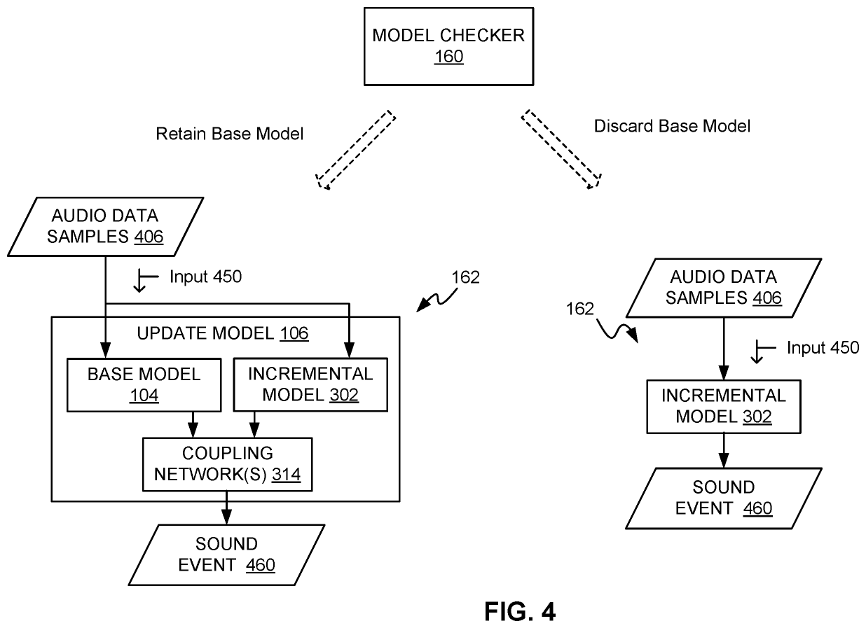

In FIG. 1, speaker(s) 118 and the microphone(s) 114 may be coupled to the CODEC 142. In a particular aspect, the microphone(s) 114 are configured to receive audio representing an acoustic environment associated with the device 100 and to generate audio data samples that the SEC engine 108 provides to the active SEC model 162 to generate a sound classification output. FIG. 4 illustrates examples of operation of the active SEC model 162 to generate output data indicating detection of a sound event. The microphone(s) 114 may also be configured to provide the audio data samples 128 to the model updater 110 or to the memory 130 for use in updating the active SEC model 162.

In the example illustrated in FIG. 1, the CODEC 142 includes a digital-to-analog converter (DAC 138) and an analog-to-digital converter (ADC 140). In a particular implementation, the CODEC 142 receives analog signals from the microphone(s) 114, converts the analog signals to digital signals using the ADC 140, and provides the digital signals to the processor(s) 132. In a particular implementation, the processor(s) 132 (e.g., the speech and music codec) provide digital signals to the CODEC 142, and the CODEC 142 converts the digital signals to analog signals using the DAC 138 and provides the analog signals to the speaker(s) 118.

In FIG. 1, the device 100 also includes an input device 122. The device 100 may also include a display 102 coupled to a display controller 112. In a particular aspect, the input device 122 includes a sensor, a keyboard, a pointing device, etc. In some implementations, the input device 122 and the display 102 are combined in a touchscreen or similar touch or motion sensitive display. The input device 122 can be used to provide a label associated with one of the audio data samples 128 to generate labeled training data used to train the update model 106. In some implementations, the device 100 also includes a modem 136 coupled a transceiver 134. In FIG. 1, the transceiver 134 is coupled to an antenna 146 to enable wireless communication with other devices, such as the remote computing device 150. In other examples, the transceiver 134 is also, or alternatively, coupled to a communication port (e.g., an ethernet port) to enable wired communication with other devices, such as the remote computing device 150.

In a particular implementation, the device 100 is included in a system-in-package or system-on-chip device 144. In a particular implementation, the memory 130, the processor 120, the processor(s) 132, the display controller 112, the CODEC 142, the modem 136, and the transceiver 134 are included in a system-in-package or system-on-chip device 144. In a particular implementation, the input device 122 and a power supply 116 are coupled to the system-on-chip device 144. Moreover, in a particular implementation, as illustrated in FIG. 1, the display 102, the input device 122, the speaker(s) 118, the microphone(s) 114, the antenna 146, and the power supply 116 are external to the system-on-chip device 144. In a particular implementation, each of the display 102, the input device 122, the speaker(s) 118, the microphone(s) 114, the antenna 146, and the power supply 116 may be coupled to a component of the system-on-chip device 144, such as an interface or a controller.

The device 100 may include, correspond to, or be included within a voice activated device, an audio device, a wireless speaker and voice activated device, a portable electronic device, a car, a vehicle, a computing device, a communication device, an internet-of-things (IoT) device, a virtual reality (VR) device, an augmented reality (AR) device, a mixed reality (MR) device, a smart speaker, a mobile computing device, a mobile communication device, a smart phone, a cellular phone, a laptop computer, a computer, a tablet, a personal digital assistant, a display device, a television, a gaming console, an appliance, a music player, a radio, a digital video player, a digital video disc (DVD) player, a tuner, a camera, a navigation device, or any combination thereof. In a particular aspect, the processor 120, the processor(s) 132, or a combination thereof, are included in an integrated circuit.

FIG. 2 is a block diagram illustrating aspects of the base model 104 according to a particular example. The base model 104 is a neural network that has a topology (e.g., a base topology 202) and trainable parameters (e.g., base parameters 236). The base topology 202 can be represented as a set of nodes and edges (or links); however, for ease of illustration and reference, the base topology 202 is represented in FIG. 2 as a set of layers. It should be understood that each layer of FIG. 2 includes a set of nodes, and that links interconnect the nodes of the different layers. The arrangement of the links depends on the type of each layer.

During training (e.g., backpropagation training), the base topology 202 is static and the base parameters 236 are changed. In FIG. 2, the base parameters 236 include base link weights 238. The base parameters 236 may also include other parameters, such as a bias value associated with one or more nodes of the base model 104.

The base topology 202 includes an input layer 204, one or more hidden layers (labeled hidden layer(s) 206 in FIG. 2), and an output layer 234. A count of input nodes of the input layer 204 depends on the arrangement of the audio data samples to be provided to the base model 104. For example, the audio data samples may include an array or matrix of data elements, with each data element corresponding to a feature of an input audio sample. As a specific example, the audio data samples can correspond to Mel spectrum features extracted from one second of audio data. In this example, the audio data samples can include a 128×128 element matrix of feature values. In other examples, other audio data sample configurations or sizes can be used. A count of nodes of the output layer 234 depends on a number of sound classes that the base model 104 is configured to detect. As an example, the output layer 234 may include one output node for each sound class.

The hidden layer(s) 206 can have various configurations and various numbers of layers depending on the specific implementations. FIG. 2 illustrates one particular example of the hidden layer(s) 206. In FIG. 2, the hidden layer(s) 206 include three convolutional neural networks (CNNs), including a CNN 208, a CNN 228, and a CNN 230. In this example, the output layer 234 includes or corresponds to an activation layer 232. For example, the activation layer 232 receives the output of the CNN 230 and applies an activation function (such as a sigmoid function) to the output to generate as output a set of data elements which each include either a one value or a zero value.

FIG. 2 also illustrates details of one particular implementation of the CNN 208, the CNN 228, and the CNN 230. In the specific example illustrated in FIG. 2, the CNN 208 includes a two-dimensional (2D) convolution layer (conv2d 210 in FIG. 2), a maxpooling layer (maxpool 216 in FIG. 2), and batch normalization layer (batch norm 226 in FIG. 2). Likewise, in FIG. 2, the CNN 228 includes a conv2d 212, a maxpool 222, and a batch norm 220, and the CNN 230 includes a conv2d 214, a maxpool 224, and a batch norm 218. In other implementations, the hidden layer(s) 206 include a different number of CNNs or other layers.

As explained above, the update model 106 includes the base model 104, a modified copy of the base model 104 (e.g., the incremental model 302 of FIG. 3), and one or more coupling networks (e.g., the coupling network(s) 314 of FIG. 3). The modified copy of the base model 104 uses the same base topology 202 as illustrated in FIG. 2 except that an output layer of the modified copy includes more output nodes than the output layer 234. Additionally, before training the update model 106, the modified copy is initialized to have the same base parameters 236 as the base model 104.

FIG. 3 is a diagram that illustrates aspects of generating the update model 106 and designating an active SEC model 162 according to a particular example. The operations described with reference to FIG. 3 can be initiated, performed, or controlled by the processor 120 or the processor(s) 132 of FIG. 1 executing the instructions 124. Alternatively, one or more of the operations described with reference to FIG. 3 may be performed by the remote computing device 150 (e.g., a server) using audio data samples 128 captured at the device 100 and audio data samples 126 from the base training data 152. In some implementations, one or more of the operations described with reference to FIG. 3 may optionally be performed by the device 100. For example, a user of the device 100 may indicate (via input or device settings) that operations of the model updater 110, the model checker 160, or both, are to be performed at the remote computing device 150; may indicate (via input or device settings) that operations of the model updater 110, the model checker 160, or both, are to be performed at the device 100; or any combination thereof. If one or more of the operations described with reference to FIG. 3 are performed at the remote computing device 150, the device 100 may download the update model 106 or a portion thereof, such as an incremental model 302, from the remote computing device 150 for use as the active SEC model 162.

The operations described with reference to FIG. 3 may be initiated automatically (e.g., without user input to start the process) or manually (e.g., in response to user input). For example, the processor(s) 120 or the processor(s) 132 may automatically initiate the operations response to detecting occurrence of a trigger event. As one example, the trigger event may be detected based on a count of unrecognized sounds or sound classes encountered. To illustrate, the operations of FIG. 3 may be automatically initiate when a threshold quantity of unrecognized sound classes have been encountered. The threshold quantity may be specified by a user (e.g., in a user setting) or may include a preconfigured or default value. In some aspects, the threshold quantity is one (e.g., a single unrecognized sound class); whereas, in other aspects, the threshold quantity is greater than one. In this example, audio data samples representing the unrecognized sound classes may be stored in a memory (e.g., the memory 130) to prepare for training the update model 106, as described further below. After the operations are automatically initiated, the user may be prompted to provide a sound event class label for one or more of the unrecognized sound classes, and the sound event class label and the one or more audio data samples of the unrecognized sound classes may be used as labeled training data. As another example, the device 100 may automatically send a request or data to the remote computing device 150 to cause the remote computing device 150 to initiate the operations described with reference to FIG. 3.

In the particular aspect, the operations described with reference to FIG. 3 may be performed offline by the device 100 or a component thereof (e.g., the processor(s) 120 or the processor(s) 132). In this context, “offline” refers to idle time periods or time periods during which input audio data is not being processed. For example, the model updater 110 may perform model update operations in the background during a period when computing resources of the device 100 are not otherwise engaged. To illustrate, the trigger event may occur when the processor(s) 120 determine to enter a sleep mode or a low power mode.

To generate the update model 106, the model updater 110 copies the base model 104 and replaces the output layer 234 of the copy of the base model 104 with a different output layer (e.g., an output layer 322 in FIG. 3) to generate an incremental model 302 (also referred to herein as a second model, in contrast with the base model 104, which is also referred to herein as a first model). The incremental model 302 includes the base topology 202 of the base model 104 except for replacement of the output layer 234 with the output layer 322 and links generated to link the output nodes of the output layer 322 to hidden layers of the incremental model 302. Model parameters of the incremental model 302 (e.g., incremental model parameters 306) are initialized to be equal to the base parameters 236. The output layer 234 of the base model 104 includes a first count of nodes (e.g., N nodes in FIG. 3, where Nis a positive integer), and the output layer 322 of the incremental model 302 includes a second count of nodes (e.g., N+K nodes in FIG. 3, where K is a positive integer). The first count of nodes corresponds to the count of sound classes of a first set of sound classes that the base model 104 is trained to recognize (e.g., the first set of sound classes includes N distinct sound classes that the base model 104 can recognize). The second count of nodes corresponds to the count of sound classes of a second set of sound classes that the update model 106 is to be trained to recognize (e.g., the second set of sound classes includes N+K distinct sound classes that the update model 106 is to be trained to recognize). Thus, the second set of sound classes includes the first set of sound classes (e.g., N classes) plus one or more additional sound classes (e.g., K classes).

In addition to generating the incremental model 302, the model updater 110 generates one or more coupling network(s) 314. In FIG. 3, the coupling network(s) 314 include a neural adapter 310 and a merger adapter 308. The neural adapter 310 includes one or more adapter layers (e.g., adapter layer(s) 312 in FIG. 3). The adapter layer(s) 312 are configured to receive input from the base model 104 and to generate output that can be merged with the output of the incremental model 302. For example, the base model 104 generates a first output 352 corresponding to the first count of classes of the first set of sound classes. In a particular aspect, the first output 352 includes one data element for each node of the output layer 234 (e.g., N data elements). In contrast, the incremental model 302 generates a second output 354 corresponding to the second count of classes of the second set of sound classes. For example, the second output 354 includes one data element for each node of the output layer 322 (e.g., N+K data elements). In this example, the adapter layer(s) 312 receive an input having the first count of data elements and generate a third output 356 having the second count of data elements (e.g., N+K). In a particular example, the adapter layer(s) 312 include two fully connected layers (e.g., an input layer including N nodes and an output layer including N+K nodes, with each node of the input layer connected to every node of the output layer).

The merger adapter 308 is configured to generate output data 318 by merging the third output 356 from the neural adapter 310 and the second output 354 from the incremental model 302. In FIG. 3, the merger adapter 308 includes an aggregation layer 316 and an output layer 320. The aggregation layer 316 is configured to combine the second output 354 and the third output 356 in an element-by-element manner. For example, the aggregation layer 316 can add each element of the third output 356 to a corresponding element of the second output 354 and provide the resulting merged output to the output layer 320. The output layer 320 is an activation layer that applies an activation function (such as a sigmoid function) to the merged output to generate the output data 318. The output data 318 includes or corresponds to a sound event identifier 360 indicating a sound class to which the update model 106 assigns a particular audio sample (e.g., one of the audio data samples 126 or 128).

In a particular aspect, the first output 352 is generated by the output layer 234 of the base model 104 (as opposed to by a layer of the base model 104 prior to the output layer 234), and the second output 352 is generated by the output layer 322 of the incremental model 302 (as opposed to by a layer of the incremental model 302 prior to the output layer 322). Stated another way, the combining networks 314 combine classification results generated by the base model 104 and the incremental model 302 rather than combining encodings generated by layers before the output layers 234, 322. Combining the classification results facilitates concurrent training of the incremental model 302 and the combining networks 314 so that the incremental model 302 can be used as a stand-alone sound event classifier if it is sufficiently accurate.

During training, the model updater 110 provides labeled training data 304 as input 350 to the base model 104 and to the incremental model 302. The labeled training data 304 includes one or more of the audio data samples 126 (which correspond to sound classes that the base model 104 is trained to recognize) and one or more audio data samples 128 (which correspond to new sound classes that the base model 104 is not trained to recognize). In response to particular audio data samples of the labeled training data 304, the base model 104 generates the first output 352 that is provided as input to the neural adapter 310. Additionally, in response to the particular audio data samples, the incremental model 302 generates the second output 354 that is provided, along with the third output 356 of the neural adapter 310, to the merger adapter 308. The merger adapter 308 merges the second output 354 and third output 356 to generate a merged output and generates the output data 318 based on the merged output.

The output data 318, the sound event identifier 360, or both, are provided to the model updater 110 which compares the sound event identifier 360 to a label associated, in the labeled training data 304, with the particular audio data samples and calculates updated link weight values (updated link weights 362 in FIG. 3) to modify the incremental model parameters 306, link weights of the neural adapter 310, link weights of the merger adapter 308, or a combination thereof. The training process continues iteratively until the model updater 110 determines that a training termination condition 370 is satisfied. For example, the model updater 110 calculates an error value based on the labeled training data 304 and the output data 318. In this example, the error value indicates how accurately the update model 106 classifies the audio data samples 126 and 128 of the labeled training data 304 based on a label associated with each of the audio data samples 126 and 128. In this example, the training termination condition 370 may be satisfied when an error value (e.g., a cross-entropy loss function) is less than a threshold or when a convergence metric (e.g., based on a rate of change of the error value) satisfies a convergence threshold. In some implementations, the termination condition 370 is satisfied when a count of training iterations performed is greater than or equal to a threshold count.

After the model updater 110 completes training of the update model 106, the model checker 160 determines whether to discard the base model 104 based on an accuracy of sound classes assigned by the incremental model 302 in the second output 354 and an accuracy of sound classes assigned by the base model 104 in the first output 352. For example, the model checker 160 may compare values of one or more metric 374 (e.g., F1-scores) that are indicative of the accuracy of sound classes assigned by the incremental model 302 to audio data samples of a first set of sound classes (e.g., the audio data samples 126) as compared to the accuracy of sound classes assigned by the base model 104 to the audio data samples of the first set of sound classes. In this example, the model checker 160 determines whether to discard the base model 104 based on values of the metric(s) 374. For example, if the value of an F1-score determined for the second output 354 is great than or equal to value of an F1-score determined for the first output 352, the model checker 160 determines to discard the base model 104. In some implementation, the model checker 160 determines to discard the base model 104 if the value of the F1-score determined for the second output 354 is less than the value of an F1-score determined for the first output 352 by less than a threshold amount.

In some aspects, the model checker 160 determines values of the metric(s) 374 during training of the update model. For example, the first output 352 and the second output 354 may be provided to the model checker 160 to determine values of the metric(s) 374 while the update model 106 is undergoing training or validation by the model updater 110. In this example, after training, the model checker 160 designates the active SEC model 162. In some implementations, a value of a metric 374 indicating the accuracy of sound classes assigned by the base model 104 to the audio data samples of the first set of sound classes may be stored in memory (e.g., the memory 130 of FIG. 1) and may be used by the model checker 160 for comparison to values of one or more other metrics 374 to determine whether to discard the base model 104.

If the model checker 160 determines to discard the base model 104, the incremental model 302 is designated the active SEC model 162. However, if the model checker 160 determines not to discard the base model 104, the update model 106 is designated the active SEC model 162.

FIG. 4 is a diagram that illustrates aspects of using the active SEC model 162 to generate sound event classification output data according to a particular example. The operations described with reference to FIG. 4 can be initiated, performed, or controlled by the processor 120 or the processor(s) 132 of FIG. 1 executing the instructions 124.

In FIG. 4, the model checker 160 determines whether to discard the base model 104 and designates the active SEC model 162 as described above. If the model checker 160 determined to retain the base model 104, the update model 106 (including the base model 104, the incremental model 302, and the coupling network(s) 314) is designated the active SEC model 162. If the model checker 160 determined to discard the base model 104, the incremental model 302 is designated the active SEC model 162.

During use (e.g., in an inference mode of operation following a training mode of operation), the SEC engine 108 provides input 450 to the active SEC model 162. The input 450 includes audio data samples 406 for which sound event identification data 460 is to be generated. In a particular example, the audio data samples 406 include, correspond to, or are based on audio captured by the microphone(s) 114 of the device 100 of FIG. 1. For example, the audio data samples 406 may correspond to features extracted from several seconds of audio data, and the input 450 may include an array or matrix of feature data extracted from the audio data. The active SEC model 162 generates the sound event identification data 460 based on the audio data samples 406. The sound event identification data 460 includes an identifier of a sound class corresponding to the audio data samples 406.

In FIG. 4, if the update model 106 is designated as the active SEC model 162, the input 450 is provided to the update model 106, which includes providing the audio data samples 406 to the base model 104 and to the incremental model 302. In response to the audio data samples 406, the base model 104 generates a first output that is provided as input to the coupling network(s) 314. As described with reference to FIG. 3, the base model 104 generates the first output using the base parameters 236, including the base link weights 238, and the first output of the base model 104 corresponds to the first count of classes of the first set of sound classes.

Additionally, in response to the audio data samples 406, the incremental model 302 generates a second output that is provided to the coupling network(s) 314. As described with reference to FIG. 3, the incremental model 302 generates the second output using updated parameters (e.g., the updated link weights 362), and the second output of the incremental model 302 corresponds to the second count of classes of the second set of sound class.

The coupling network(s) 314 generate the sound event identification data 460 that is based on the first output of the base model 104 and the second output of the incremental model 302. For example, the first output of the base model 104 is used to generate a third output that corresponds to the second count of classes of the second set of sound class, and the third output is merged with the second output of the incremental model 302 to form a merged output. The merged output is processed to generate the sound event identification data 460 which indicates a sound class associated with the audio data samples 406.

In FIG. 4, if the incremental model 302 is designated as the active SEC model 162, the base model 104 and coupling network(s) 314 are discarded. In this situation, the input 450 is provided to the incremental model 302 (and not to the base model 104). In response to the audio data samples 406, the incremental model 302 generates the sound event identification data 460, which indicates a sound class associated with the audio data samples 406.

Thus, the model checker 160 facilitates use of significantly fewer computing resources when the metric(s) 374 indicate that the base model 104 can be discarded and the incremental model 302 can be used as the active SEC model 162. For example, since the update model 106 includes both the base model 104 and the incremental model 302, more memory is used to store the update model 106 than is used to store only the incremental model 302. Similarly, determining a sound event class associated with particular audio data samples 406 using the update model 106 uses more processor time than determining a sound event class associated with particular audio data samples 406 using only the incremental update model 302.

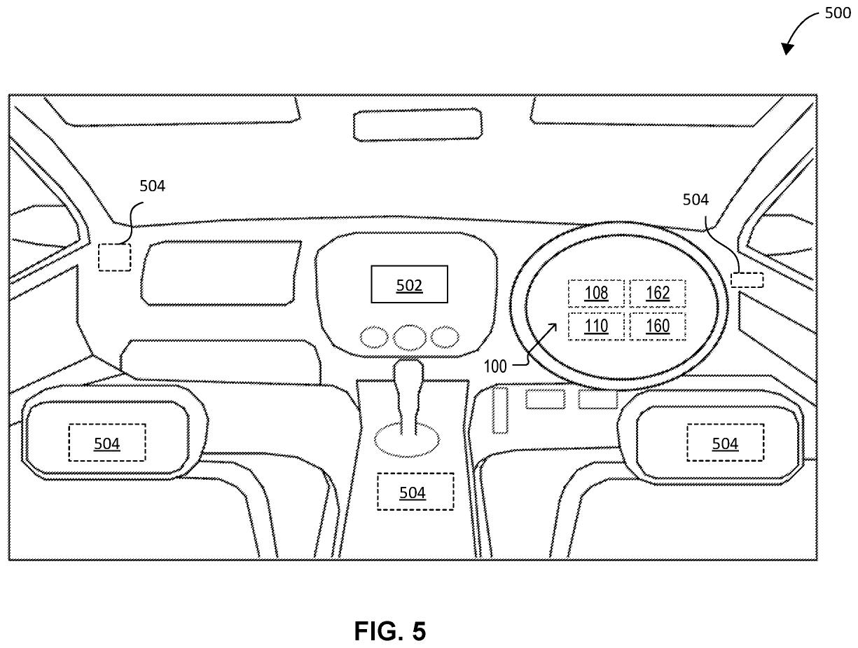

FIG. 5 is an illustrative example of a vehicle 500 that incorporates aspects of the device 100 of FIG. 1. According to one implementation, the vehicle 500 is a self-driving car. According to other implementations, the vehicle 500 is a car, a truck, a motorcycle, an aircraft, a water vehicle, etc. In FIG. 5, the vehicle 500 includes a screen 502 (e.g., a display, such as the display 102 of FIG. 1), sensor(s) 504, the device 100, or a combination thereof. The sensor(s) 504 and the device 100 are shown using a dotted line to indicate that these components might not be visible to passengers of the vehicle 500. The device 100 can be integrated into the vehicle 500 or coupled to the vehicle 500.

In a particular aspect, the device 100 is coupled to the screen 502 and provides an output to the screen 502 responsive to the active SEC model 162 detecting or recognizing various events (e.g., sound events) described herein. For example, the device 100 provides the sound event identification data 460 of FIG. 4 to the screen 502 indicating that a recognized sound event, such as a car horn, is detected in audio data received from the sensor(s) 504. In some implementations, the device 100 can perform an action responsive to recognizing a sound event, such as activating a camera or one of the sensor(s) 504. In a particular example, the device 100 provides an output that indicates whether an action is being performed responsive to the recognized sound event. In a particular aspect, a user can select an option displayed on the screen 502 to enable or disable a performance of actions responsive to recognized sound events.

In a particular implementations, the sensor(s) 504 include one or more microphone(s) 114 of FIG. 1, vehicle occupancy sensors, eye tracking sensor, or external environment sensors (e.g., lidar sensors or cameras). In a particular aspect, sensor input of the sensor(s) 504 indicates a location of the user. For example, the sensor(s) 504 are associated with various locations within the vehicle 500.

The device 100 in FIG. 5 includes the SEC engine 108, the model updater 110, the model checker 160, and the active SEC model 162. However, in other implementations, the device 100, when installed in or used in the vehicle 500, omits the model updater 110, the model checker 160, or both. To illustrate, the remote computing device 150 of FIG. 1 may generate the active SEC model 162. In such implementations, the active SEC model 162 can be downloaded to the vehicle 500 for used by the SEC engine 108.

Thus, the techniques described with respect to FIGS. 1-4 enable a user of the vehicle 500 to generate an updated sound event classification model (e.g., a customize active SEC model 162) that is able to detect a new set of sound classes. In addition, the sound event classification model can be updated without excessive use of computing resources onboard the vehicle 500. For example, the vehicle 500 does not have to store all of the base training data 152 used train the base model 104 in a local memory in order to avoid forgetting training associated with the base training data 152. Rather, the model updater 110 retains the base model 104 while generating the update model 106 and then determines whether the base model 104 can be discarded.

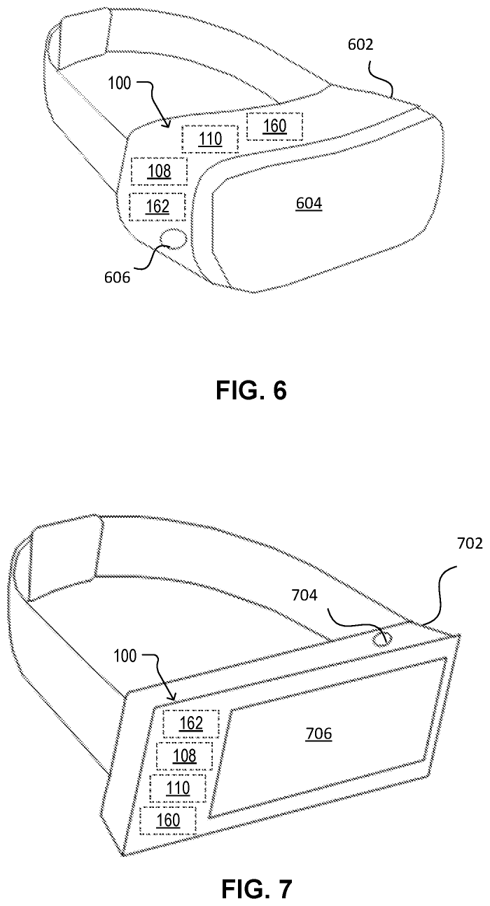

FIG. 6 depicts an example of the device 100 coupled to or integrated within a headset 602, such as a virtual reality headset, an augmented reality headset, a mixed reality headset, an extended reality headset, a head-mounted display, or a combination thereof. A visual interface device, such as a display 604, is positioned in front of the user's eyes to enable display of augmented reality or virtual reality images or scenes to the user while the headset 602 is worn. In a particular example, the display 604 is configured to display output of the device 100, such as an indication of a recognized sound event (e.g., the sound event identification data 460). The headset 602 can include one or more sensor(s) 606, such as microphone(s) 114 of FIG. 1, cameras, other sensors, or a combination thereof. Although illustrated in a single location, in other implementations one or more of the sensor(s) 606 can be positioned at other locations of the headset 602, such as an array of one or more microphones and one or more cameras distributed around the headset 602 to detect multi-modal inputs.

The sensor(s) 606 enable detection of audio data, which the device 100 uses to detect sound events or to update the active SEC model 162. For example, the device 100 uses the active SEC model 162 to generate the sound event identification data 460 which may be provided to the display 604 to indicate that a recognized sound event, such as a car horn, is detected in audio data samples received from the sensor(s) 606. In some implementations, the device 100 can perform an action responsive to recognizing a sound event, such as activating a camera or one of the sensor(s) 606 or providing haptic feedback to the user.

In the example illustrated in FIG. 6, the device 100 includes the SEC engine 108, the model updater 110, the model checker 160, and the active SEC model 162. However, in other implementations, the device 100, when installed in or used in the headset 602, omits the model updater 110, the model checker 160, or both. To illustrate, the remote computing device 150 of FIG. 1 may generate the active SEC model 162. In such implementations, the active SEC model 162 can be downloaded to the headset 602 for used by the SEC engine 108.

FIG. 7 depicts an example of the device 100 integrated into a wearable electronic device 702, illustrated as a “smart watch,” that includes a display 706 (e.g., the display 102 of FIG. 1) and sensor(s) 704. The sensor(s) 704 enable detection, for example, of user input based on modalities such as video, speech, and gesture. The sensor(s) 704 also enable detection of audio data, which the device 100 uses to detect sound events or to update the active SEC model 162. For example, the sensor(s) 704 may include or correspond to the microphone(s) 114 of FIG. 1.

The sensor(s) 704 enable detection of audio data, which the device 100 uses to detect sound events or to update the active SEC model 162. For example, the device 100 provides the sound event identification data 460 of FIG. 4 to the display 706 indicating that a recognized sound event is detected in audio data samples received from the sensor(s) 704. In some implementations, the device 100 can perform an action responsive to recognizing a sound event, such as activating a camera or one of the sensor(s) 704 or providing haptic feedback to the user.

In the example illustrated in FIG. 7, the device 100 includes the SEC engine 108, the model updater 110, the model checker 160, and the active SEC model 162. However, in other implementations, the device 100, when installed in or used in the wearable electronic device 702, omits the model updater 110, the model checker 160, or both. To illustrate, the remote computing device 150 of FIG. 1 may generate the active SEC model 162. In such implementations, the active SEC model 162 can be downloaded to the wearable electronic device 702 for used by the SEC engine 108.

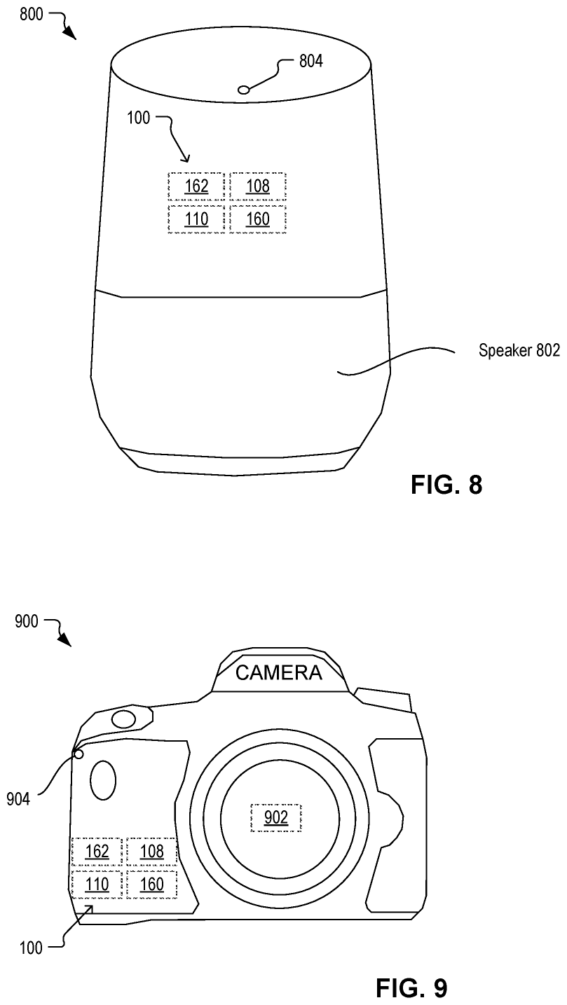

FIG. 8 is an illustrative example of a voice-controlled speaker system 800. The voice-controlled speaker system 800 can have wireless network connectivity and is configured to execute an assistant operation. In FIG. 8, the device 100 is included in the voice-controlled speaker system 800. The voice-controlled speaker system 800 also includes a speaker 802 and sensor(s) 804. The sensor(s) 804 can include one or more microphone(s) 114 of FIG. 1 to receive voice input or other audio input.

During operation, in response to receiving a verbal command, the voice-controlled speaker system 800 can execute assistant operations. The assistant operations can include adjusting a temperature, playing music, turning on lights, etc. The sensor(s) 804 enable detection of audio data samples, which the device 100 uses to detect sound events or to generate the active SEC model 162. Additionally, the voice-controlled speaker system 800 can execute some operations based on sound events recognized by the device 100. For example, if the device 100 recognizes the sound of a door closing, the voice-controlled speaker system 800 can turn on one or more lights.

In the example illustrated in FIG. 8, the device 100 includes the SEC engine 108, the model updater 110, the model checker 160, and the active SEC model 162. However, in other implementations, the device 100, when installed in or used in the voice-controlled speaker system 800, omits the model updater 110, the model checker 160, or both. To illustrate, the remote computing device 150 of FIG. 1 may generate the active SEC model 162. In such implementations, the active SEC model 162 can be downloaded to the voice-controlled speaker system 800 for use by the SEC engine 108.

FIG. 9 illustrates a camera 900 that incorporates aspects of the device 100 of FIG. 1. In FIG. 9, the device 100 is incorporated in or coupled to the camera 900. The camera 900 includes an image sensor 902 and one or more other sensors 904, such as the microphone(s)114 of FIG. 1. Additionally, the camera 900 includes the device 100, which is configured to identify sound events based on audio data samples from the sensor(s) 904. For example, the camera 900 may cause the image sensor 902 to capture an image in response to the device 100 detecting a particular sound event in the audio data samples from the sensor(s) 904.

In the example illustrated in FIG. 9, the device 100 includes the SEC engine 108, the model updater 110, the model checker 160, and the active SEC model 162. However, in other implementations, the device 100, when installed in or used in the camera 900, omits the model updater 110, the model checker 160, or both. To illustrate, the remote computing device 150 of FIG. 1 may generate the active SEC model 162. In such implementations, the active SEC model 162 can be downloaded to the camera 900 for used by the SEC engine 108.

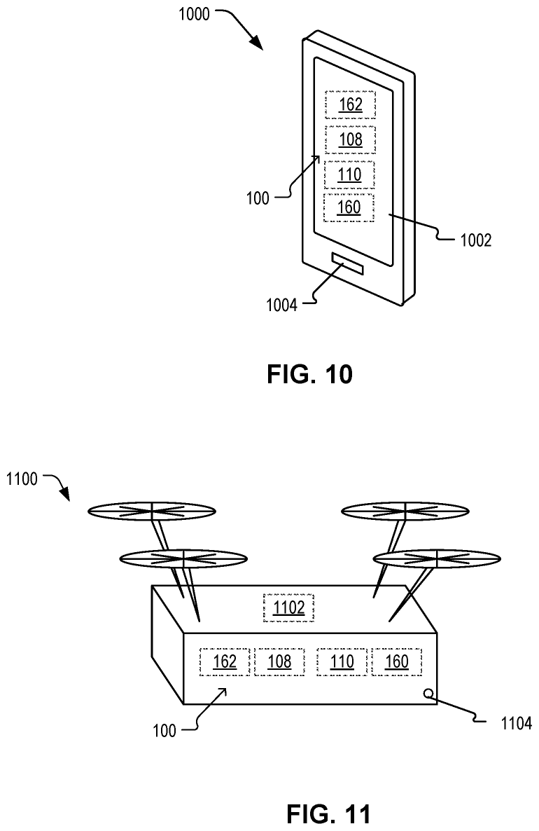

FIG. 10 illustrates a mobile device 1000 that incorporates aspects of the device 100 of FIG. 1. In FIG. 10, the mobile device 1000 includes or is coupled to the device 100 of FIG. 1. The mobile device 1000 includes a phone or tablet, as illustrative, non-limiting examples. The mobile device 1000 includes a display screen 1002 and one or more sensors 1004, such as the microphone(s) 114 of FIG. 1.

During operation, the mobile device 1000 may perform particular actions in response to the device 100 detecting particular sound events. For example, the actions can include sending commands to other devices, such as a thermostat, a home automation system, another mobile device, etc. The sensor(s) 1004 enable detection of audio data, which the device 100 uses to detect sound events or to generate the update model 106.

In the example illustrated in FIG. 10, the device 100 includes the SEC engine 108, the model updater 110, the model checker 160, and the active SEC model 162. However, in other implementations, the device 100, when installed in or used in the mobile device 1000, omits the model updater 110, the model checker 160, or both. To illustrate, the remote computing device 150 of FIG. 1 may generate the active SEC model 162. In such implementations, the active SEC model 162 can be downloaded to the mobile device 1000 for used by the SEC engine 108.

FIG. 11 illustrates an aerial device 1100 that incorporates aspects of the device 100 of FIG. 1. In FIG. 11, the aerial device 1100 includes or is coupled to the device 100 of FIG. 1. The aerial device 1100 is a manned, unmanned, or remotely piloted aerial device (e.g., a package delivery drone). The aerial device 1100 includes a control system 1102 and one or more sensors 1104, such as the microphone(s) 114 of FIG. 1. The control system 1102 controls various operations of the aerial device 1100, such as cargo release, sensor activation, take-off, navigation, landing, or combinations thereof. For example, the control system 1102 may control fly the aerial device 1100 between specified points and deployment of cargo at a particular location. In a particular aspect, the control system 1102 performs one or more action responsive to detection of a particular sound event by the device 100. To illustrate, the control system 1102 may initiate a safe landing protocol in response to the device 100 detecting an aircraft engine.

In the example illustrated in FIG. 11, the device 100 includes the SEC engine 108, the model updater 110, the model checker 160, and the active SEC model 162. However, in other implementations, the device 100, when installed in or used in the aerial device 1100, omits the model updater 110, the model checker 160, or both. To illustrate, the remote computing device 150 of FIG. 1 may generate the active SEC model 162. In such implementations, the active SEC model 162 can be downloaded to the aerial device 1100 for used by the SEC engine 108.

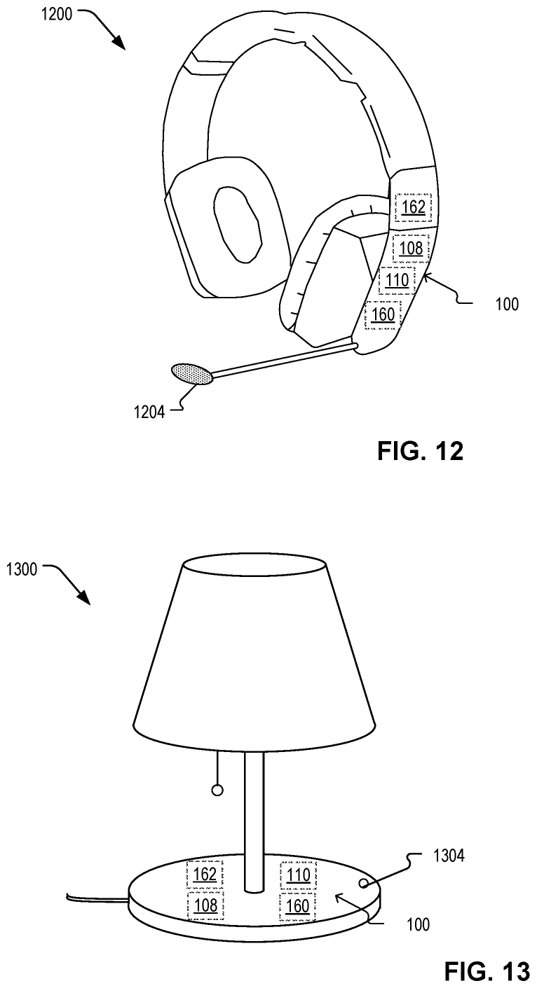

FIG. 12 illustrates a headset 1200 that incorporates aspects of the device 100 of FIG. 1. In FIG. 12, the headset 1200 includes or is coupled to the device 100 of FIG. 1. The headset 1200 includes a microphone 1204 (e.g., one of the microphone(s) 114 of FIG. 1) positioned to primarily capture speech of a user. The headset 1200 may also include one or more additional microphone positioned to primarily capture environmental sounds (e.g., for noise canceling operations). In a particular aspect, the headset 1200 performs one or more actions responsive to detection of a particular sound event by the device 100. To illustrate, the headset 1200 may activate a noise cancellation feature in response to the device 100 detecting a gunshot.

In the example illustrated in FIG. 12, the device 100 includes the SEC engine 108, the model updater 110, the model checker 160, and the active SEC model 162. However, in other implementations, the device 100, when installed in or used in the headset 1200, omits the model updater 110, the model checker 160, or both. To illustrate, the remote computing device 150 of FIG. 1 may generate the active SEC model 162. In such implementations, the active SEC model 162 can be downloaded to the headset 1200 for used by the SEC engine 108.

FIG. 13 illustrates an appliance 1300 that incorporates aspects of the device 100 of FIG. 1. In FIG. 13, the appliance 1300 is a lamp; however, in other implementations, the appliance 1300 includes another Internet-of-Things appliance, such as a refrigerator, a coffee maker, an oven, another household appliance, etc. The appliance 1300 includes or is coupled to the device 100 of FIG. 1. The appliance 1300 includes one or more sensors 1304, such as the microphone(s) 114 of FIG. 1. In a particular aspect, the appliance 1300 performs one or more actions responsive to detection of a particular sound event by the device 100. To illustrate, the appliance 1300 may activate a light in response to the device 100 detecting a door closing.

In the example illustrated in FIG. 13, the device 100 includes the SEC engine 108, the model updater 110, the model checker 160, and the active SEC model 162. However, in other implementations, the device 100, when installed in or used in the appliance 1300, omits the model updater 110, the model checker 160, or both. To illustrate, the remote computing device 150 of FIG. 1 may generate the active SEC model 162. In such implementations, the active SEC model 162 can be downloaded to the appliance 1300 for used by the SEC engine 108.

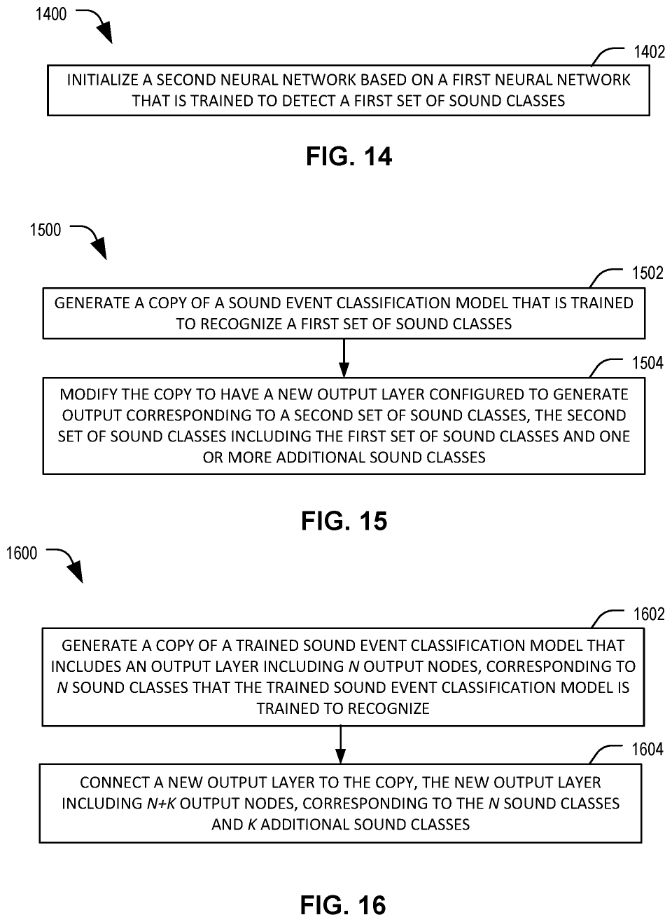

FIG. 14 is a flow chart illustrating aspects of an example of a method 1400 of generating a sound event classifier using the device of FIG. 1. The method 1400 can be initiated, controlled, or performed by the device 100. For example, the processor(s) 120 or 132 of FIG. 1 can execute instructions 124 from the memory 130 to perform the method 1400.

The method 1400 includes, at block 1402, initializing a second neural network based on a first neural network that is trained to detect a first set of sound classes. For example, the model updater 110 can initialize the incremental model 302 by generating a copy of the input layer 204, hidden layers 206 and base link weights 238 of the base model 104 (e.g., the first neural network) and couple the copies of the input layer 204, hidden layers 206 to a new output layer 322 to form the incremental model 302 (e.g., the second neural network).

Thus, the method 1400 facilitates use of transfer learning techniques to generate an updated sound event classification model based on a previously trained sound event classification model. The use of such transfer learning techniques reduces the computing resources (e.g., memory, processor cycles, etc.) used to train a sound event classification model from scratch.

FIG. 15 is a flow chart illustrating aspects of an example of a method 1500 of generating a sound event classifier using the device of FIG. 1. The method 1500 can be initiated, controlled, or performed by the device 100. For example, the processor(s) 120 or 132 of FIG. 1 can execute instructions 124 from the memory 130 to perform the method 1500.

The method 1500 includes, at block 1502, generating a copy of a sound event classification model that is trained to recognize a first set of sound classes. For example, the model updater 110 can generate a copy of the input layer 204, hidden layers 206 and base link weights 238 of the base model 104 (e.g., the first neural network).

The method 1500 includes, at block 1504, modifying the copy to have a new output layer configured to generate output corresponding to a second set of sound classes, the second set of sound classes including the first set of sound classes and one or more additional sound classes. For example, the model updater 110 can couple the copies of the input layer 204, hidden layers 206 to a new output layer 322 to form the incremental model 302 (e.g., the second neural network). In this example, the incremental model 302 is configured to generate output corresponding to a second set of sound classes (e.g., the first set of sound classes plus one or more additional sound classes).

Thus, the method 1500 facilitates use of transfer learning techniques to generate an updated sound event classification model based on a previously trained sound event classification model. The updated sound event classification model is configured to detect more types of sound events than the base model is. The use of such transfer learning techniques reduces the computing resources (e.g., memory, processor cycles, etc.) used to train a sound event classification model that detects more sound events than previously trained sound event classification models.

FIG. 16 is a flow chart illustrating aspects of an example of a method 1600 of generating a sound event classifier using the device of FIG. 1. The method 1600 can be initiated, controlled, or performed by the device 100. For example, the processor(s) 120 or 132 of FIG. 1 can execute instructions 124 from the memory 130 to perform the method 1600.

The method 1600 includes, at block 1602, generating a copy of a trained sound event classification model that includes an output layer including N output nodes corresponding to N sound classes that the trained sound event classification model is trained to recognize. For example, the model updater 110 can generate a copy of the input layer 204, hidden layers 206 and base link weights 238 of the base model 104 (e.g., the first neural network). In this example, the output layer 234 of the base model 104 includes N nodes, where N corresponds to the number of sound classes that the based model 104 is trained to recognize.

The method 1600 includes, at block 1604, connecting a new output layer to the copy, the new output layer including N+K output nodes corresponding to the N sound classes and K additional sound classes. For example, the model updater 110 can couple the copies of the input layer 204, hidden layers 206 to a new output layer 322 to form the incremental model 302 (e.g., the second neural network). In this example, the new output layer 322 includes K+N output nodes corresponds to the N sound classes that the base model 104 is trained to recognize and K additional sound classes.

Thus, the method 1600 facilitates use of transfer learning techniques to learn to detect new sound events based on a previously trained sound event classification model. The new sound events include a prior set of sound event classes and one or more additional sound classes. The use of such transfer learning techniques reduce the computing resources (e.g., memory, processor cycles, etc.) used to train from scratch a sound event classification model that detects more sound events than previously trained sound event classification models.

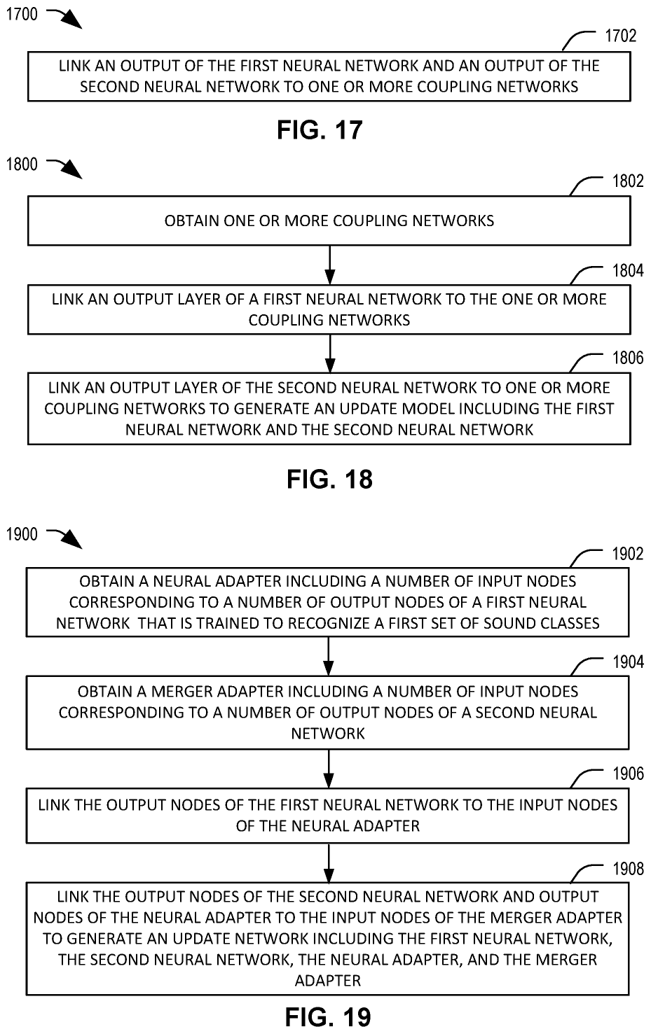

FIG. 17 is a flow chart illustrating aspects of an example of a method 1700 of generating a sound event classifier using the device of FIG. 1. The method 1700 can be initiated, controlled, or performed by the device 100. For example, the processor(s) 120 or 132 of FIG. 1 can execute instructions 124 from the memory 130 to perform the method 1700.

The method 1700 includes, at block 1702, linking an output of the first neural network and an output of the second neural network to one or more coupling networks. For example, the model updater 110 of FIG. 1 generates the coupling network(s) 314 and links the coupling network(s) 314 to the base model 104 and the incremental model 302, as illustrated in FIG. 3.

Thus, the method 1700 facilitates use of coupling networks to facilitate transfer learning to learn to detect new sound events based on a previously trained sound event classification model. The use of the coupling networks and transfer learning reduces the computing resources (e.g., memory, processor cycles, etc.) used to train from scratch a sound event classification model that detects more sound events than previously trained sound event classification models.

FIG. 18 is a flow chart illustrating aspects of an example of a method 1800 of generating a sound event classifier using the device of FIG. 1. The method 1800 can be initiated, controlled, or performed by the device 100. For example, the processor(s) 120 or 132 of FIG. 1 can execute instructions 124 from the memory 130 to perform the method 1800.

The method 1800 includes, at block 1802, obtaining one or more coupling networks. For example, the model updater 110 of FIG. 1 may generate the coupling network(s) 314 including, for example, the neural adapter 310 and the merger adapter 308. In another example, the model update 110 may obtain the coupling network(s) 314 from a memory (e.g., from a library of available coupling networks).

The method 1800 includes, at block 1804, linking an output layer of a first neural network to the one or more coupling networks. For example, the model updater 110 of FIG. 1 may link the coupling network(s) 314 to the base model 104 and the incremental model 302, as illustrated in FIG. 3.

The method 1800 includes, at block 1806, linking an output layer of the second neural network to one or more coupling networks to generate an update model including the first neural network and the second neural network. For example, the model updater 110 of FIG. 1 may link an output of the base model 104 and an output of the incremental model 302 to one or more coupling networks, as illustrated in FIG. 3.

Thus, the method 1800 facilitates use of coupling networks and transfer learning to generate a new sound event classification model based on a previously trained sound event classification model. The use of the coupling networks and transfer learning reduces the computing resources (e.g., memory, processor cycles, etc.) used to train the new sound event classification model from scratch.

FIG. 19 is a flow chart illustrating aspects of an example of a method 1900 of generating a sound event classifier using the device of FIG. 1. The method 1900 can be initiated, controlled, or performed by the device 100. For example, the processor(s) 120 or 132 of FIG. 1 can execute instructions 124 from the memory 130 to perform the method 1900.

The method 1900 includes, at block 1902, obtaining a neural adapter including a number of input nodes corresponding to a number of output nodes of a first neural network that is trained to recognize a first set of sound classes. For example, the model updater 110 of FIG. 1 may generate the neural adapter 310 based on the output layer 234 of the base model 104. In another example, the model update 110 may obtain the neural adapter 310 from a memory (e.g., from a library of available neural adapters). The neural adapter 310 includes the same number of input nodes as the number of output nodes of the output layer 234 of the base model 104. The neural adapter 310 may also include the same number of output nodes as the number of output nodes of the output layer 322 of the incremental model 302 of FIG. 3.

The method 1900 includes, at block 1904, obtaining a merger adapter including a number of input nodes corresponding to a number of output nodes of a second neural network. For example, the model updater 110 of FIG. 1 may generate the merger adapter 308 based on the output layer 322 of the incremental model 302. In another example, the model update 110 may obtain the merger adapter 308 from a memory (e.g., from a library of available merger adapters). To illustrate, the merger adapter 308 includes the same number of input nodes as the number of output nodes of the output layer 322 of the incremental model 302 of FIG. 3.

The method 1900 includes, at block 1906, linking the output nodes of the first neural network to the input nodes of the neural adapter. For example, the model updater 110 of FIG. 1 links the output layer 234 of the base model 104 to the neural adapter 310.

The method 1900 includes, at block 1908, linking the output nodes of the second neural network and output nodes of the neural adapter to the input nodes of the merger adapter to generate an update network including the first neural network, the second neural network, the neural adapter, and the merger adapter. For example, the model updater 110 of FIG. 1 links the output layer 322 of the incremental model 302 and the output of the neural adapter 310 to the input of the merger adapter 308.

Thus, the method 1900 facilitates use of a neural adapter and a merger adapter with transfer learning to generate a new sound event classification model based on a previously trained sound event classification model. The use of the neural adapter and a merger adapter with the transfer learning reduces the computing resources (e.g., memory, processor cycles, etc.) used to train the new sound event classification model from scratch.

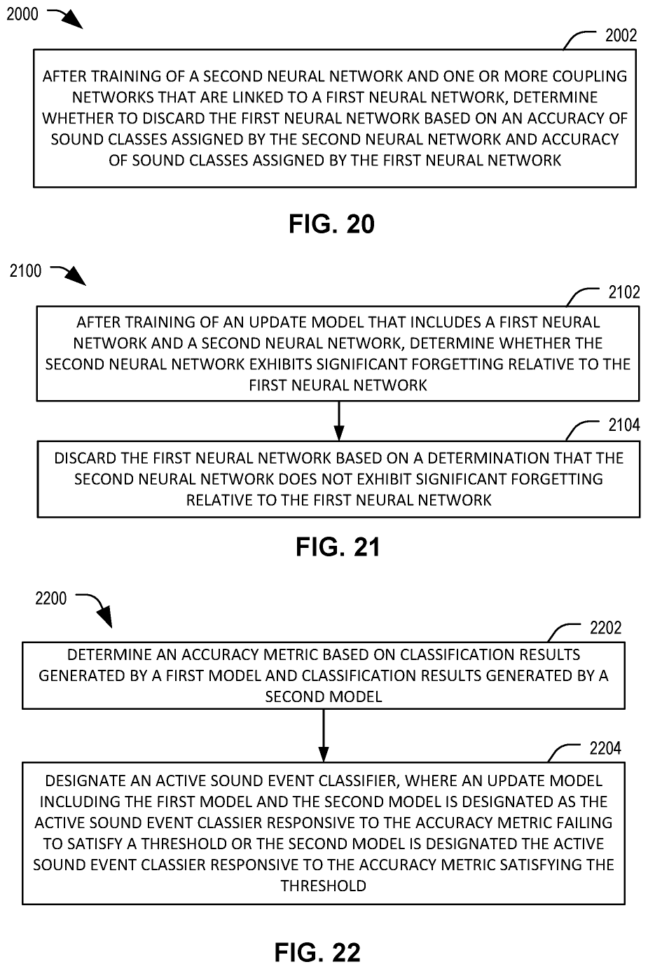

FIG. 20 is a flow chart illustrating aspects of an example of a method 2000 of generating a sound event classifier using the device of FIG. 1. The method 2000 can be initiated, controlled, or performed by the device 100. For example, the processor(s) 120 or 132 of FIG. 1 can execute instructions 124 from the memory 130 to perform the method 2000.

The method 2000 includes, at block 2002, after training of a second neural network and one or more coupling networks that are linked to a first neural network, determining whether to discard the first neural network based on an accuracy of sound classes assigned by the second neural network and accuracy of sound classes assigned by the first neural network. For example, in FIG. 3, the model checker 160 determines values of one or more metrics 374 that are indicative of the accuracy of sound classes assigned by the base model 104 and the accuracy of sound classes assigned by the incremental model 302. The model checker 160 makes a determination whether to discard the base model 104 based on the value(s) of the metric(s) 374. If the model checker 160 determines to discard the base model 104, the incremental model 302 is designated as the active SEC model 162. If the model checker 160 determines not to discard the base model 104, the update model 106 is designated as the active SEC model 162.

Thus, the method 2000 facilitates designation an active sound event classifier in a manner that conserves computing resources. For example, if the second neural network alone is sufficiently accurate, the first neural network and the one or more coupling networks are discarded, which reduces an in-memory footprint of the active sound event classifier.

FIG. 21 is a flow chart illustrating aspects of an example of a method 2100 of generating a sound event classifier using the device of FIG. 1. The method 2100 can be initiated, controlled, or performed by the device 100. For example, the processor(s) 120 or 132 of FIG. 1 can execute instructions 124 from the memory 130 to perform the method 2100.

The method 2100 includes, at block 2102, after training of an update model that includes a first neural network and a second neural network, determining whether the second neural network exhibits significant forgetting relative to the first neural network. For example, in FIG. 3, the model checker 160 determines values of one or more metrics 374 that are indicative of the accuracy of sound classes assigned by the base model 104 and the accuracy of sound classes assigned by the incremental model 302. Comparison of the one or more metrics 374 indicates whether the incremental model 302 exhibits significant forgetting of the prior training of the base model 104.

The method 2100 includes, at block 2104, discarding the first neural network based on a determination that the second neural network does not exhibit significant forgetting relative to the first neural network. The model checker 160 discards the base model 104 and the coupling networks 314 in response to determining that the one or more metrics 374 indicate that the incremental model 302 does not exhibit significant forgetting of the prior training of the base model 104.

Thus, the method 2100 facilitates conservation of computing resources when training an updated sound event classifier (e.g., the second neural network). For example, if the second neural network alone is sufficiently accurate, the first neural network and the one or more coupling networks are discarded, which reduces an in-memory footprint of the active sound event classifier.

FIG. 22 is a flow chart illustrating aspects of an example of a method 2200 of generating a sound event classifier using the device of FIG. 1. The method 2200 can be initiated, controlled, or performed by the device 100. For example, the processor(s) 120 or 132 of FIG. 1 can execute instructions 124 from the memory 130 to perform the method 2200.

The method 2200 includes, at block 2202, determining an accuracy metric based on classification results generated by a first model and classification results generated by a second model. For example, the model checker 160 may determine a value of an F1-score or another accuracy metric based on the accuracy of sound classes assigned by the incremental model 302 to audio data samples of a first set of sound classes as compared to the accuracy of sound classes assigned by the base model 104 to the audio data samples of the first set of sound classes.

The method 2200 includes, at block 2204, designating an active sound event classifier, where an update model including the first model and the second model is designated as the active sound event classifier responsive to the accuracy metric failing to satisfy a threshold or the second model is designated the active sound event classifier responsive to the accuracy metric satisfying the threshold. For example, if the value of an F1-score determined for the second output 354 is greater than or equal to value of an F1-score determined for the first output 352 of FIG. 3, the model checker 160 designates the incremental model 302 as the active sound event classifier and discards the base model 104 and the coupling networks 314. In some implementations, the model checker 160 designates the incremental model 302 as the active sound event classifier if the value of the F1-score determined for the second output 354 is less than the value of an F1-score determined for the first output 352 by less than a threshold amount. The model checker 160 designates the update model 106 as the active sound event classifier if the value of the F1-score determined for the second output 354 is less than the value of an F1-score determined for the first output 352 by more than a threshold amount.

Thus, the method 2200 facilitates designation of an active sound event classifier in a manner that conserves computing resources. For example, if the second neural network alone is sufficiently accurate, the first neural network and the one or more coupling networks are discarded, which reduces an in-memory footprint of the active sound event classifier.

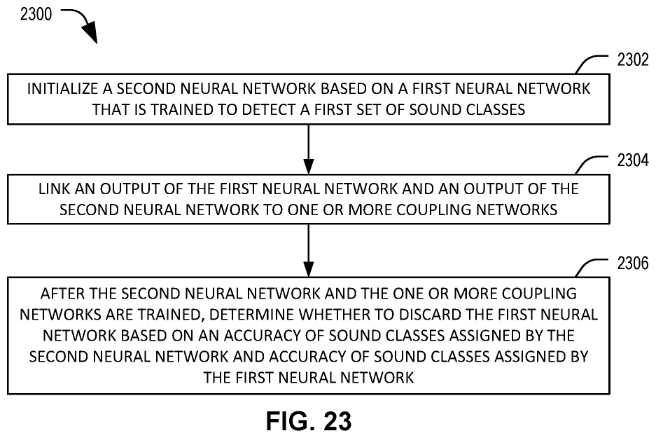

FIG. 23 is a flow chart illustrating aspects of an example of a method 2300 of generating a sound event classifier using the device of FIG. 1. The method 2300 can be initiated, controlled, or performed by the device 100. For example, the processor(s) 120 or 132 of FIG. 1 can execute instructions 124 from the memory 130 to cause the model updater 110 to generate and train the update model 106 and to cause the model checker 160 to determine whether to discard the base model 104 and designate an active SEC model 162.

In block 2302, the method 2300 includes initializing a second neural network based on a first neural network that is trained to detect a first set of sound classes. For example, the model updater 110 can generate a copy of the input layer 204, hidden layers 206 and base link weights 238 of the base model 104 (e.g., the first neural network) and couple the copies of the input layer 204, hidden layers 206 to a new output layer 322 to form the incremental model 302 (e.g., the second neural network). In this example, the base model 104 includes the output layer 234 that generates output corresponding to a first count of classes of a first set of sound classes, and the incremental model 302 includes the output layer 322 that generates output corresponding to a second count of classes of a second set of sound classes.

In block 2304, the method 2300 includes linking an output of the first neural network and an output of the second neural network to one or more coupling networks. For example, the model updater 110 of FIG. 1 generates the coupling network(s) 314 and links the coupling network(s) 314 to the base model 104 and the incremental model 302, as illustrated in FIG. 3.

In block 2306, the method 2300 includes, after the second neural network and the one or more coupling networks are trained, determining whether to discard the first neural network based on an accuracy of sound classes assigned by the second neural network and an accuracy of sound classes assigned by the first neural network. For example, in FIG. 3, the model checker 160 determines values of one or more metrics 374 that are indicative of the accuracy of sound classes assigned by the base model 104 and the accuracy of sound classes assigned by the incremental model 302. The model checker 160 makes a determination whether to discard the base model 104 based on the value(s) of the metric(s) 374. If the model checker 160 determines to discard the base model 104, the incremental model 302 is designated as the active SEC model 162. If the model checker 160 determines not to discard the base model 104, the update model 106 is designated as the active SEC model 162.

Thus, the method 2300 facilitates conservation of computing resources when training an updated sound event classifier (e.g., the second neural network). For example, if the second neural network alone is sufficiently accurate, the first neural network and the one or more coupling networks are discarded, which reduces an in memory footprint of the active sound event classifier.

In conjunction with the described implementations, an apparatus includes means for initializing a second neural network based on a first neural network that is trained to detect a first set of sound classes. For example, the means for initializing the second neural network based on the first neural network includes the remote computing device 150, the device 100, the instructions 124, the processor 120, the processor(s) 132, the model updater 110, one or more other circuits or components configured to initialize a second neural network based on a first neural network, or any combination thereof. In some aspects, the means for initializing the second neural network based on the first neural network includes means for generating copies of the input layer and the hidden layers of the first neural network and means for connecting a second output layer to the copies of the input layer and the hidden layers. For example, the means for generating copies of the input layer and the hidden layers of the first neural network and means for connecting the second output layer to the copies of the input layer and the hidden layers include the remote computing device 150, the device 100, the instructions 124, the processor 120, the processor(s) 132, the model updater 110, one or more other circuits or components configured generate copies of the input layer and the hidden layers of the first neural network and connect a second output layer to the copies of the input layer and the hidden layers, or any combination thereof.

The apparatus also includes means for linking an output of the first neural network and an output of the second neural network to one or more coupling networks. For example, the means for linking the first neural network and the second neural network to one or more coupling networks includes the remote computing device 150, the device 100, the instructions 124, the processor 120, the processor(s) 132, the model updater 110, one or more other circuits or components configured to link the first neural network and the second neural network to one or more coupling networks, or any combination thereof.

The apparatus also includes means for determining, after the second neural network and the one or more coupling networks are trained, whether to discard the first neural network based on an accuracy of sound classes assigned by the second neural network and an accuracy of sound classes assigned by the first neural network. For example, the means for determining whether to discard the first neural network includes the remote computing device 150, the device 100, the instructions 124, the processor 120, the processor(s) 132, the model updater 110, the model checker 160, one or more other circuits or components configured to determine whether to discard a neural network or to designate an active SEC model, or any combination thereof.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Particular aspects of the disclosure are described below in a first set of interrelated clauses:

According to Clause 1, a device includes one or more processors. The one or more processors are configured to initialize a second neural network based on a first neural network that is trained to detect a first set of sound classes and to link an output of the first neural network and an output of the second neural network as input to one or more coupling networks. The one or more processors are configured to, after the second neural network and the one or more coupling networks are trained, determine whether to discard the first neural network based on an accuracy of sound classes assigned by the second neural network and an accuracy of sound classes assigned by the first neural network.

Clause 2 includes the device of Clause 1 wherein the one or more processors are further configured to determine a value of a metric indicative of the accuracy of sound classes assigned by the second neural network to audio data samples of the first set of sound classes as compared to the accuracy of sound classes assigned by the first neural network to the audio data samples of the first set of sound classes, and the one or more processors are configured to determine whether to discard the first neural network further based on the value of the metric.

Clause 3 includes the device of Clause 1 or clause 2 wherein the output of the first neural network indicates a sound class assigned to particular audio data samples by the first neural network and the output of the second neural network indicates a sound class assigned to the particular audio data samples by the second neural network.

Clause 4 includes the device of any of Clauses 1 to 3 wherein the output of the first neural network includes a first count of data elements corresponding to a first count of sound classes of the first set of sound classes, the output of the second neural network includes a second count of data elements corresponding to a second count of sound classes of a second set of sound classes, and the one or more coupling networks include a neural adapter comprising one or more adapter layers configured to generate, based on the output of the first neural network, a third output having the second count of data elements.

Clause 5 includes the device of Clause 4 wherein the one or more coupling networks include a merger adapter including one or more aggregation layers configured to merge the third output from the neural adapter and the output of the second neural network and including an output layer to generate a merged output.

Clause 6 includes the device of any of Clauses 1 to 5 wherein an output layer of the first neural network includes N output nodes, and an output layer of the second neural network includes N+K output nodes, where N is an integer greater than or equal to one, and K is an integer greater than or equal to one.

Clause 7 includes the device of Clause 6 wherein the N output nodes correspond to N sound event classes that the first neural network is trained to recognize and the N+K output nodes include the N output nodes correspond to the N sound event classes and K output nodes correspond to K additional sound event classes.

Clause 8 includes the device of any of Clauses 1 to 7 wherein, prior to initializing the second neural network, the first neural network is designated as an active sound event classifier and the one or more processors are configured to designate the second neural network as the active sound event classifier based on a determination to discard the first neural network.

Clause 9 includes the device of any of Clauses 1 to 8 wherein, prior to initializing the second neural network, the first neural network is designated as an active sound event classifier and the one or more processors are configured to designate the first neural network, the second neural network, and the one or more coupling networks together as the active sound event classifier based on a determination not to discard the first neural network.

Clause 10 includes the device of any of Clauses 1 to 9 wherein the one or more processors are integrated within a mobile computing device.

Clause 11 includes the device of any of Clauses 1 to 9 wherein the one or more processors are integrated within a vehicle.

Clause 12 includes the device of any of Clauses 1 to 9 wherein the one or more processors are integrated within a wearable device.

Clause 13 includes the device of any of Clauses 1 to 9 wherein the one or more processors are integrated within an augmented reality headset, a mixed reality headset, or a virtual reality headset.

Clause 14 includes the device of any of Clauses 1 to 13 wherein the one or more processors are included in an integrated circuit.

Particular aspects of the disclosure are described below in a second set of interrelated clauses:

According to a Clause 15, a method includes initializing a second neural network based on a first neural network that is trained to detect a first set of sound classes and linking an output of the first neural network and an output of the second neural network to one or more coupling networks. The method also includes, after the second neural network and the one or more coupling networks are trained, determining whether to discard the first neural network based on an accuracy of sound classes assigned by the second neural network and an accuracy of sound classes assigned by the first neural network.

Clause 16 includes the method of Clause 15 and further includes determining a value of a metric indicative of the accuracy of sound classes assigned by the second neural network to audio data samples of the first set of sound classes as compared to the accuracy of sound classes assigned by the first neural network to the audio data samples of the first set of sound classes, and wherein a determination of whether to discard the first neural network is further based on the value of the metric.

Clause 17 includes the method of Clause 15 or Clause 16 wherein the second neural network is initialized automatically based on detecting a trigger event.

Clause 18 includes the method of clause 17 wherein the trigger event is based on encountering a threshold quantity of unrecognized sound classes.

Clause 19 includes the method of clause 17 or clause 18 wherein the trigger event is specified by a user setting.

Clause 20 includes the method of any of Clauses 15 to 19 wherein the first neural network includes an input layer, hidden layers, and a first output layer, and wherein initializing the second neural network based on the first neural network includes generating copies of the input layer and the hidden layers of the first neural network and connecting a second output layer to the copies of the input layer and the hidden layers, wherein the first output layer includes a first count of output nodes corresponding to a count of sound classes of the first set of sound classes and the second output layer includes a second count of output node corresponding to a count of sound classes of the second set of sound classes.

Clause 21 includes the method of any of Clauses 15 to 20 wherein the output of the first neural network indicates a sound class assigned to particular audio data samples by the first neural network and the output of the second neural network indicates a sound class assigned to the particular audio data samples by the second neural network.

Clause 22 includes the method of Clause 21 wherein the one or more coupling networks are configured to generate merged output that indicates a sound class assigned to the particular audio data samples by the one or more coupling networks based on the output of the first neural network and the output of the second neural network.

Clause 23 includes the method of any of Clauses 15 to 22 and further includes determining a first value indicating the accuracy of sound classes assigned by the first neural network to audio data samples of the first set of sound classes and determining a second value indicating the accuracy of the sound classes assigned by the second neural network to the audio data samples of the first set of sound classes, wherein the determining whether to discard the first neural network is based on a comparison of the first value and the second value.

Clause 24 includes the method of any of Clauses 15 to 23 wherein the output of the first neural network includes a first count of data elements corresponding to a first count of sound classes of the first set of sound classes, the output of the second neural network includes a second count of data elements corresponding to a second count of sound classes of the second set of sound classes, and the one or more coupling networks include a neural adapter including one or more adapter layers configured to generate, based on the output of the first neural network, a third output having the second count of data elements.

Clause 25 includes the method of Clause 24 wherein the one or more coupling networks include a merger adapter including one or more aggregation layers configured to merge the third output from the neural adapter and the output of the second neural network and include an output layer to generate a merged output.

Clause 26 includes the method of any of Clauses 15 to 25 wherein link weights of the first neural network are not updated during the training of the second neural network and the one or more coupling networks.

Clause 27 includes the method of any of Clauses 15 to 26 wherein, prior to initializing the second neural network, the first neural network is designated as an active sound event classifier, and further including designating the second neural network as the active sound event classifier based on a determination to discard the first neural network.

Clause 28 includes the method of any of Clauses 15 to 27 wherein, prior to initializing the second neural network, the first neural network is designated as an active sound event classifier, and further including designating the first neural network, the second neural network, and the one or more coupling networks together as the active sound event classifier based on a determination not to discard the first neural network.

Particular aspects of the disclosure are described below in a third set of interrelated clauses:

According to a Clause 29, a device includes means for initializing a second neural network based on a first neural network that is trained to detect a first set of sound classes and means for linking an output of the first neural network and an output of the second neural network to one or more coupling networks. The device also includes means for determining, after the second neural network and the one or more coupling networks are trained, whether to discard the first neural network based on an accuracy of sound classes assigned by the second neural network and an accuracy of sound classes assigned by the first neural network.

Clause 30 includes the device of Clause 29 and further includes means for determining a value of a metric indicative of the accuracy of sound classes assigned by the second neural network to audio data samples of the first set of sound classes as compared to the accuracy of sound classes assigned by the first neural network to the audio data samples of the first set of sound classes, and wherein the means for determining whether to discard the first neural network is configured to determine whether to discard the first neural network based on the value of the metric.

Clause 31 includes the device of Clause 29 or Clause 30 wherein the means for determining whether to discard the first neural network is configured to discard the first neural network based on determining that the second neural network does not exhibit significant forgetting relative to the first neural network.

Clause 32 includes the device of any of Clauses 29 to 31 wherein the first neural network includes an input layer, hidden layers, and a first output layer, and wherein the means for initializing the second neural network includes means for generating copies of the input layer and the hidden layers of the first neural network and means for connecting a second output layer to the copies of the input layer and the hidden layers, where the first output layer includes a first count of output nodes corresponding to a count of sound classes of the first set of sound classes and the second output layer includes a second count of output node corresponding to a count of sound classes of a second set of sound classes.

Particular aspects of the disclosure are described below in a fourth set of interrelated clauses:

According to a Clause 33, a non-transitory computer-readable storage medium includes instructions that when executed by a processor, cause the processor to initialize a second neural network based on a first neural network that is trained to detect a first set of sound classes and link an output of the first neural network and an output of the second neural network to one or more coupling networks. The instructions, when executed by the processor, also cause the processor to, after the second neural network and the one or more coupling networks are trained, determine whether to discard the first neural network based on an accuracy of sound classes assigned by the second neural network and an accuracy of sound classes assigned by the first neural network.

Clause 34 includes the non-transitory computer-readable storage medium of Clause 33 and the instructions, when executed by the processor, further cause the processor to determine a value of a metric indicative of the accuracy of sound classes assigned by the second neural network to audio data samples of the first set of sound classes as compared to the accuracy of sound classes assigned by the first neural network to the audio data samples of the first set of sound classes, and wherein a determination of whether to discard the first neural network is further based on the value of the metric.

Clause 35 includes the non-transitory computer-readable storage medium of Clause 33 or 34 wherein the first neural network includes an input layer, hidden layers, and a first output layer, and wherein initializing the second neural network based on the first neural network includes generating copies of the input layer and the hidden layers of the first neural network and connecting a second output layer to the copies of the input layer and the hidden layers, wherein the first output layer includes a first count of output nodes corresponding to a count of sound classes of the first set of sound classes and the second output layer includes a second count of output node corresponding to a count of sound classes of a second set of sound classes.

Clause 36 includes the non-transitory computer-readable storage medium of any of Clauses 33 to 34 wherein the output of the first neural network indicates a sound class assigned to particular audio data samples by the first neural network and the output of the second neural network indicates a sound class assigned to the particular audio data samples by the second neural network.

Clause 37 includes the non-transitory computer-readable storage medium of Clause 36 wherein the one or more coupling networks are configured to generate merged output that indicates a sound class assigned to the particular audio data samples by the one or more coupling networks based on the output of the first neural network and the output of the second neural network.

Clause 38 includes the non-transitory computer-readable storage medium of any of Clauses 33 to 37 and the instructions, when executed by the processor, further cause the processor to determine a first value indicating the accuracy of sound classes assigned by the first neural network to audio data samples of the first set of sound classes and determine a second value indicating the accuracy of the sound classes assigned by the second neural network to the audio data samples of the first set of sound classes, wherein the determination whether to discard the first neural network is based on a comparison of the first value and the second value.

Clause 39 includes the non-transitory computer-readable storage medium of any of Clauses 33 to 38 wherein the output of the first neural network includes a first count of data elements corresponding to a first count of sound classes of the first set of sound classes, the output of the second neural network includes a second count of data elements corresponding to a second count of sound classes of the second set of sound classes, and the one or more coupling networks include a neural adapter including one or more adapter layers configured to generate, based on the output of the first neural network, a third output having the second count of data elements.

Clause 40 includes the non-transitory computer-readable storage medium of Clause 39 wherein the one or more coupling networks include a merger adapter including one or more aggregation layers configured to merge the third output from the neural adapter and the output of the second neural network and include an output layer to generate a merged output.

Clause 41 includes the non-transitory computer-readable storage medium of any of Clauses 33 to 40 wherein link weights of the first neural network are not updated during the training of the second neural network and the one or more coupling networks.

Clause 42 includes the non-transitory computer-readable storage medium of any of Clauses 33 to 41 wherein, prior to initializing the second neural network, the first neural network is designated as an active sound event classifier, and further including designating the second neural network as the active sound event classifier based on a determination to discard the first neural network.

Clause 43 includes the non-transitory computer-readable storage medium of any of Clauses 33 to 42 wherein, prior to initializing the second neural network, the first neural network is designated as an active sound event classifier, and further including designating the first neural network, the second neural network, and the one or more coupling networks together as the active sound event classifier based on a determination not to discard the first neural network.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
initialize a second neural network based on a first neural network that is trained to detect a first set of sound classes;
link an output of the first neural network and an output of the second neural network as input to one or more coupling networks; and
after the second neural network and the one or more coupling networks are trained, determining whether to discard the first neural network based on an accuracy of sound classes assigned by the second neural network and an accuracy of sound classes assigned by the first neural network.

2. The device of claim 1, wherein the one or more processors are further configured to determine a value of a metric indicative of the accuracy of sound classes assigned by the second neural network to audio data samples of the first set of sound classes as compared to the accuracy of sound classes assigned by the first neural network to the audio data samples of the first set of sound classes, and wherein the one or more processors are configured to determine whether to discard the first neural network further based on the value of the metric.

3. The device of claim 1, wherein the output of the first neural network indicates a sound class assigned to particular audio data samples by the first neural network and the output of the second neural network indicates a sound class assigned to the particular audio data samples by the second neural network.

4. The device of claim 1, wherein the output of the first neural network includes a first count of data elements corresponding to a first count of sound classes of the first set of sound classes, the output of the second neural network includes a second count of data elements corresponding to a second count of sound classes of a second set of sound classes, and the one or more coupling networks include a neural adapter comprising one or more adapter layers configured to generate, based on the output of the first neural network, a third output having the second count of data elements.

5. The device of claim 4, wherein the one or more coupling networks include a merger adapter including one or more aggregation layers configured to merge the third output from the neural adapter and the output of the second neural network and including an output layer to generate a merged output.

6. The device of claim 1, wherein an output layer of the first neural network includes N output nodes, and an output layer of the second neural network includes N+K output nodes, where N is an integer greater than or equal to one, and K is an integer greater than or equal to one.

7. The device of claim 6, wherein the N output nodes correspond to N sound event classes that the first neural network is trained to recognize and the N+K output nodes include the N output nodes correspond to the N sound event classes and K output nodes correspond to K additional sound event classes.

8. The device of claim 1, wherein, prior to initializing the second neural network, the first neural network is designated as an active sound event classifier and the one or more processors are configured to designate the second neural network as the active sound event classifier based on a determination to discard the first neural network.

9. The device of claim 1, wherein, prior to initializing the second neural network, the first neural network is designated as an active sound event classifier and the one or more processors are configured to designate the first neural network, the second neural network, and the one or more coupling networks together as the active sound event classifier based on a determination not to discard the first neural network.

10. The device of claim 1, wherein the one or more processors are integrated within a mobile computing device.

11. The device of claim 1, wherein the one or more processors are integrated within a vehicle.

12. The device of claim 1, wherein the one or more processors are integrated within one or more of an augmented reality headset, a mixed reality headset, a virtual reality headset, or a wearable device.

13. The device of claim 1, wherein the one or more processors are included in an integrated circuit.

14. A method comprising:
initializing a second neural network based on a first neural network that is trained to detect a first set of sound classes;
linking an output of the first neural network and an output of the second neural network to one or more coupling networks; and
after the second neural network and the one or more coupling networks are trained, determining whether to discard the first neural network based on an accuracy of sound classes assigned by the second neural network and an accuracy of sound classes assigned by the first neural network.

15. The method of claim 14, further comprising determining a value of a metric indicative of the accuracy of sound classes assigned by the second neural network to audio data samples of the first set of sound classes as compared to the accuracy of sound classes assigned by the first neural network to the audio data samples of the first set of sound classes, and wherein a determination of whether to discard the first neural network is further based on the value of the metric.

16. The method of claim 14, wherein the second neural network is initialized and linking is performed automatically based on detecting a trigger event.

17. The method of claim 16, wherein the trigger event is based on encountering a threshold quantity of unrecognized sound classes.

18. The method of claim 16, wherein the trigger event is specified by a user setting.

19. The method of claim 14, wherein the first neural network includes an input layer, hidden layers, and a first output layer, and wherein initializing the second neural network based on the first neural network comprises:
generating copies of the input layer and the hidden layers of the first neural network; and
connecting a second output layer to the copies of the input layer and the hidden layers, wherein the first output layer includes a first count of output nodes corresponding to a count of sound classes of the first set of sound classes and the second output layer includes a second count of output node corresponding to a count of sound classes of a second set of sound classes.

20. The method of claim 14, wherein the output of the first neural network indicates a sound class assigned to particular audio data samples by the first neural network and the output of the second neural network indicates a sound class assigned to the particular audio data samples by the second neural network.

21. The method of claim 20, wherein the one or more coupling networks are configured to generate merged output that indicates a sound class assigned to the particular audio data samples by the one or more coupling networks based on the output of the first neural network and the output of the second neural network.

22. The method of claim 14, further comprising:
determining a first value indicating the accuracy of sound classes assigned by the first neural network to audio data samples of the first set of sound classes; and
determining a second value indicating the accuracy of the sound classes assigned by the second neural network to the audio data samples of the first set of sound classes,
wherein the determining whether to discard the first neural network is based on a comparison of the first value and the second value.

23. The method of claim 14, wherein the output of the first neural network includes a first count of data elements corresponding to a first count of sound classes of the first set of sound classes, the output of the second neural network includes a second count of data elements corresponding to a second count of sound classes of a second set of sound classes, and the one or more coupling networks include a neural adapter comprising one or more adapter layers configured to generate, based on the output of the first neural network, a third output having the second count of data elements.

24. The method of claim 23, wherein the one or more coupling networks include a merger adapter including one or more aggregation layers configured to merge the third output from the neural adapter and the output of the second neural network and include an output layer to generate a merged output.

25. The method of claim 14, wherein link weights of the first neural network are not updated during the training of the second neural network and the one or more coupling networks.

26. The method of claim 14, wherein, prior to initializing the second neural network, the first neural network is designated as an active sound event classifier, and further comprising designating the second neural network as the active sound event classifier based on a determination to discard the first neural network.

27. The method of claim 14, wherein, prior to initializing the second neural network, the first neural network is designated as an active sound event classifier, and further comprising designating the first neural network, the second neural network, and the one or more coupling networks together as the active sound event classifier based on a determination not to discard the first neural network.

28. A device comprising:
means for initializing a second neural network based on a first neural network that is trained to detect a first set of sound classes;
means for linking an output of the first neural network and an output of the second neural network to one or more coupling networks; and
means for determining, after the second neural network and the one or more coupling networks are trained, whether to discard the first neural network based on an accuracy of sound classes assigned by the second neural network and an accuracy of sound classes assigned by the first neural network.

29. The device of claim 28, further comprising means for determining a value of a metric indicative of the accuracy of sound classes assigned by the second neural network to audio data samples of the first set of sound classes as compared to the accuracy of sound classes assigned by the first neural network to the audio data samples of the first set of sound classes, and wherein the means for determining whether to discard the first neural network is configured to determine whether to discard the first neural network based on the value of the metric.

30. A non-transitory computer-readable storage medium, the computer-readable storage medium including instructions that when executed by a processor, cause the processor to:
initialize a second neural network based on a first neural network that is trained to detect a first set of sound classes;
link an output of the first neural network and an output of the second neural network to one or more coupling networks; and
after training the second neural network and the one or more coupling networks, determine whether to discard the first neural network based on an accuracy of sound classes assigned by the second neural network and an accuracy of sound classes assigned by the first neural network.
